(19) United States
(12) Patent Application Publication
(10) Pub. No.: US 2024/0127177 A1
(43) Pub. Date: Apr. 18, 2024

(54) METHODS AND DEVICES FOR ITEM TRACKING IN CLOSED ENVIRONMENTS

(71) Applicant: Intel Corporation, Santa Clara, CA (US)

(72) Inventors: Rita H. WOUHAYBI, Portland, OR (US); Frederik PASCH, Karlsruhe (DE); Priyanka MUDGAL, Portland, OR (US); Fabian OBORIL, Karlsruhe (DE); Cornelius BUERKLE, Karlsruhe (DE); Greeshma PISHARODY, Portland, OR (US)

(21) Appl. No.: 18/398,207

(22) Filed: Dec. 28, 2023

(51) Int. Cl. G06Q 10/087; G08B 21/24; H04W 4/38

(52) U.S. Cl. CPC G06Q 10/087; G08B 21/24; H04W 4/38

(57) ABSTRACT

An apparatus including a memory and a processor configured to: identify an item located within the environment based on sensor data, wherein the sensor data represents one or more sensor detections of the environment; determine a metric representative of a likelihood of the item becoming lost the within the environment based on information about the item; and select, based on the metric, at least one monitoring method to monitor the item within the environment from a plurality of monitoring methods.

### TECHNICAL FIELD

This disclosure generally relates to methods and devices for item tracking in closed environments.

### BACKGROUND

In closed environments like warehouses, item tracking may be an important aspect for efficiency of inventory management systems (IMSs). Traditionally, item tracking may be associated with a meticulous process of monitoring and tracing the journey of every item within the closed environment, from its arrival through storage to departure. Through item tracking, it may be desired to obtain real-time visibility into inventory levels, locations, and movements. In some examples, item tracking may involve various technologies such as barcodes, RFID (Radio-Frequency Identification), or computer vision systems to identify and document status and whereabouts of each item within the environment.

IMSs may be employed to oversee and control all aspects of inventory within a facility, such as warehouses, in which an IMS may be configured to orchestrate, control, and oversee various aspects of inventory handling. An IMS may provide various functionalities ranging from receiving and storing items to order fulfillment and shipment of items for the purpose of optimization of warehouse space, efficient allocation of warehouse resources, and timely fulfillment of item-related actions.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 shows an exemplary and schematically overview of a storage facility environment;

FIG. 2 is an illustrative example showing schematically a control system of a storage facility;

FIG. 3 is an illustrative example showing schematically a plurality of image acquisition devices deployed within the storage facility;

FIG. 4 shows an illustrative example of an apparatus;

FIG. 5 shows an illustrative example of schematic representation of a storage facility control system;

FIG. 6 shows an illustrative example of an apparatus;

FIG. 7 shows an illustrative example of a storage facility environment;

FIG. 8 shows an exemplary storage facility environment;

FIG. 9 shows an illustrative example of a messaging diagram;

FIG. 10 shows an example of a method;

FIG. 11 shows an example of a method.

### DESCRIPTION

The following detailed description refers to the accompanying drawings that show, by way of illustration, exemplary details and aspects in which aspects of the present disclosure may be practiced.

Storage facilities, such as warehouses, are fundamental for managing items within an inventory. They provide an organized space for temporarily housing materials after their arrival and before their transfer to another location in the logistics chain for dispatch. Despite employing conventional security measures to protect stored items, these measures may become inadequate as the quantity of stored items increases.

A storage facility environment may house various types of items, materials, goods (referred as items thereon) having a variety of sizes, shapes, costs, etc. Generally, a storage facility may be used to store items for a temporary period from their reception of a respective item until distribution of the item to a retailer, wholesaler, customer, another storage facility, etc. Therefore, it may play an important role during a journey of an item intended to be delivered from one location to another.

From a high-level perspective, storage facilities may typically include various designated storage areas (i.e. physical storage units) such as shelves, racks and other type of physical storage units designated for items having different physical attributes. Such a physical attribute may be the size of items. Exemplary, a plurality of racks may be designed to store relatively smaller items, such as accessories preserved in relatively smaller boxes, whereas other racks may be designed to store larger items, such as televisions preserved in relatively larger boxes. Another physical attribute may be the shape of items stored in the storage facility.

An item may be associated with various physical attributes. In addition to its size and shape, physical attributes of an item may include color of an item, a texture of an item, a barcode and/or a label provided on the item, damage or defects of an item, serial numbers or identifiers disposed on an item, orientation and/or position of an item, a weight of an item, etc. It is further to be noted that an item in this context may include a packaging (e.g. a box, a wrapping, etc.) having a content item. In other words, physical attributes may be associated with the packaging of the content item.

Apart from the racks or other physical storage units, the storage facility may include an open field. The phrase “open field” may refer to a section of the storage facility not occupied by the physical storage units or any other physical obstacles within the storage facility in order to allow in-facility transportation of the items. Therefore, human operators and/or autonomous machines such as autonomous mobile robots (AMRs) may be able to perform a specified task within the storage facility. In some aspects, autonomous machines and human operators may collaborate to carry out the specified task, whereas, in some aspects, the task may be performed by either one or more human operators or one or more automated machines.

Performing one or more tasks may include one or more actions of the autonomous machine and/or the human operators, e.g., one or more spatially distributed actions (e.g., a spatial sequence of actions) and/or one or more spatially chronological actions (e.g., in a chronologic sequence of operations). The spatial distribution of multiple actions (also referred to as machine actions) may indicate, where (i.e., with which spatial relation) and/or in which direction the autonomous machine provides the one or more actions, i.e. in which corresponding spatial position (i.e. position and/or orientation) the autonomous machine or its tool is located.

The one or more tasks may be represented (e.g., logically) by data (also referred to as task data). A task may refer to one task or a group of multiple tasks, which are related to each other, e.g., contextually or logically related to each other (for example, tasks directed to the fabrication of a certain product, tasks directed to the exploration of a certain are, and the like). The task data may be a formal representation of the task. Examples of the task data may include: data identifying each task (also referred to as task identifier), data organizing each task (e.g., spatial and/or chronological data), data indicating the criteria under which a task is fulfilled, data indicating goals of each task, data identifying criteria for triggering, terminating, or maintaining a task, etc.

Furthermore, the task data may include a task logic, which logically links tasks, priorities, criteria, conditions, and/or tasks and/or which implements a sequence (e.g., a flow chart), according to which the task is executed. For example, the task logic may organize the task hierarchically, e.g., into hierarchical levels, hierarchical groups, subtasks, and the like. For example, a task may include multiple subtasks on a lower hierarchical level, which may be, but not need to be, prioritized, contextual based, and/or conditional. Viewed from the hierarchical level of the subtask, the subtask may also be referred to as task, and may include, but not need to include, multiple subtasks. For example, the task logic may organize the task in accordance with conditional aspects and/or contextual aspects. For example, the task logic may define conditional tasks, e.g., by defining conditions/requirements to be fulfilled for starting a task performance and/or for ending a task performance.

Herein the term “collaborate”, “collaborative”, “collaboration” refers to entities, such as devices (a plurality of autonomous machines), methods and functions, as examples, participating to accomplish a task. Examples of the collaborative entities may include various types of agents or actors, such as automated machines (e.g., partially of fully autonomous machines), humans, non-automated machines, or non-autonomous machines. Multiple entities (e.g., autonomous machines) participating in the task may be affiliated (e.g., assigned) to a group (herein also referred to as group, swarm, team, or as a cluster), e.g., being members (also referred to as agents or as nodes) of the group. Multiple autonomous machines participating in the task may be affiliated (e.g., assigned) to a group (e.g. cluster) of autonomous machines (herein also referred to as group, swarm, team or cluster), e.g., being members (also referred to as agents or as nodes) of the group of autonomous machines. Each group (e.g., of autonomous machines) may be entrusted with one or more tasks.

References made herein with respect to a group of autonomous machines may analogously apply to a group of entities, e.g., including various types of agents or actors, such as automated machines (e.g., partially of fully autonomous machines), humans, non-automated machines, or non-autonomous machines. The autonomous machine may be configured to collaborate with one or more other autonomous machine or one or more human operators, e.g., by implementing one or more protocols (also referred to as collaboration protocols). Examples of collaboration protocols may include: a protocol for group management (also referred to as group management protocol), a protocol for communication (e.g., data exchange) between members of a group of collaborating autonomous machines and/or human operators (also referred to as group communication protocol), a protocol for managing tasks (also referred to as task management protocol).

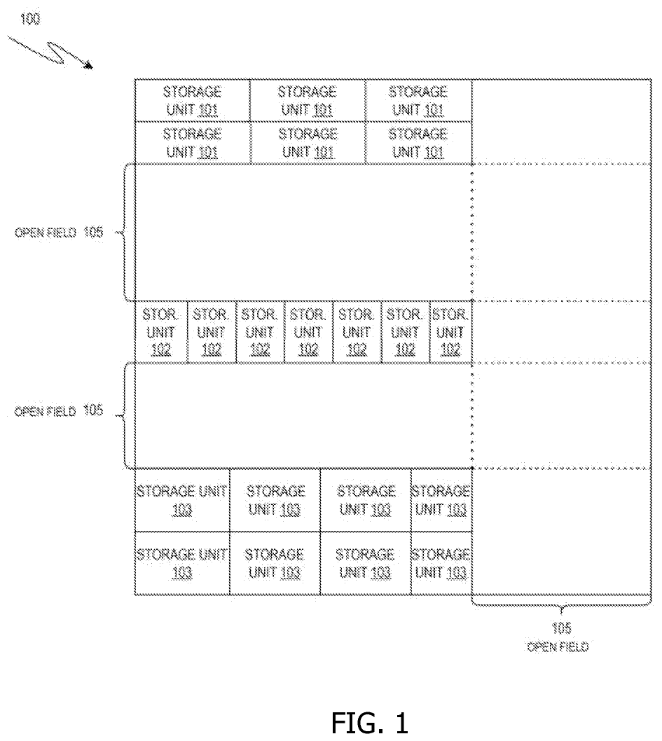

FIG. 1 shows an exemplary and schematically overview of a storage facility. The storage facility 100 may include physical storage units designated for the items with different sizes and/or different shapes. For example, where the storage unit 101 may store relatively wider items such as a television, the storage unit 102 may store relatively compact items, such as mobile phones. The storage unit 103 may be designed to store relatively heavier and larger items such as washing machines, etc. Although it is depicted that the storage units (i.e., physical storage units) may form an array of identical storage units, the storage facility 100 may have an array of storage units designed to store different sized items. FIG. 1 further depicts an open field 105. The open field 105 may refer to an area not occupied by storage units or other physical materials that would be an obstacle for an AMR or a human operator. Accordingly, the open field 105 may be intended to provide a maneuvering and/or navigating area for an AMR and/or a human operator to transport an item of interest from one location to another within the storage facility. Human operators and/or AMRs may make use of variety of vehicles suitable to transport an item within the storage facility 100. The vehicles may include forklifts, crabs, conveyors and the like.

The storage facility 100 may further include doors or any apertures to accept the items into the storage facility 100 and/or dispatch the items from the storage facility 100. The skilled person would recognize that there may be further entities established within the storage facility 100. Exemplary, the storage facility 100 may include a changing room for human operators and/or supervisors, an isolated area for management activities, etc. The storage facility 100 may refer to a closed facility with storing capabilities for a plurality of items according to various aspects of the disclosure. However, it may be possible to describe an open-air territory as the storage facility 100.

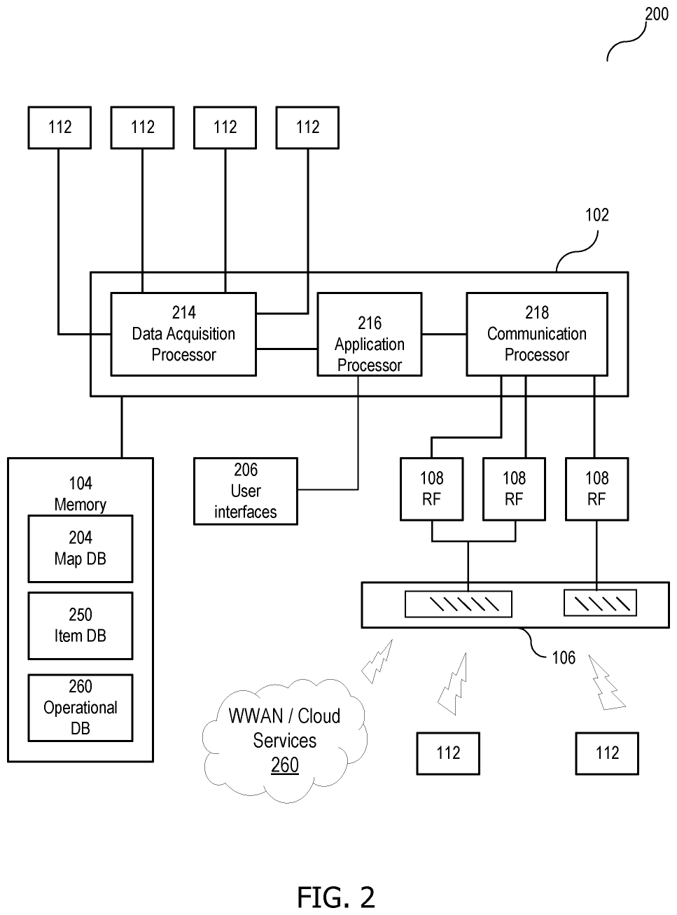

FIG. 2 is an illustrative example showing schematically a control system of a storage facility. The control system 200 may include various components depending on the requirements of a particular implementation. The control system 200 may include one or more processors 102, one or more memories 104, an antenna system 106 which may include multiple antennas provided at different locations of a storage facility (e.g. the storage facility 100) for radio frequency (RF) coverage, one or more radio frequency (RF) transceivers 108, one or more data acquisition devices 112.

The control system 200 may be configured to control the operations of the storage facility 100 via various entities and/or interactions with its environment, e.g. communications with other devices within the storage facility, such as storage facility actors, monitoring entities, data acquisition devices 112 or network infrastructure elements (NIEs), and the radio frequency communication arrangement including the one or more RF transceivers 108 and antenna system 106.

The one or more processors 102 may include a data acquisition processor 214, an application processor 216, a communication processor 218, and/or any other suitable processing device. Each processor 214, 216, 218 of the one or more processors 102 may include various types of hardware-based processing devices. By way of example, each processor 214, 216, 218 may include a microprocessor, pre-processors (such as an image pre-processor), graphics processors, a CPU, support circuits, digital signal processors, integrated circuits, memory, or any other types of devices suitable for running applications and for image processing and analysis. Each processor 214, 216, 218 may include any type of single or multi-core processor, mobile device microcontroller, central processing unit, etc. These processor types may each include multiple processing units with local memory and instruction sets. Such processors may include video inputs for receiving image data from multiple image sensors and may also include video out capabilities.

Any of the processors 214, 216, 218 disclosed herein may be configured to perform certain functions in accordance with program instructions which may be stored in a memory of the one or more memories 104. In other words, a memory of the one or more memories 104 may store software that, when executed by a processor (e.g., by the one or more processors 102), controls various operations associated with the storage facility. A memory of the one or more memories 104 may store one or more databases and image processing software, as well as a trained system, such as a neural network, or a deep neural network, for example. The one or more memories 104 may include any number of random-access memories, read only memories, flash memories, disk drives, optical storage, tape storage, removable storage and other types of storage. Alternatively, each of processors 214, 216, 218 may include an internal memory for such storage.

The data acquisition processor 214 may include processing circuitry, such as a CPU, for processing data acquired by data acquisition devices 112. For example, if one or more data acquisition devices 112 are image acquisition units including sensors e.g. one or more cameras, then the data acquisition processor 214 may include image processors for processing image data using the information obtained from the image acquisition units as an input. The data acquisition processor 214 may therefore be configured to create pixel or voxel maps detailing the interior of the storage facility based on the data input from the data acquisition devices 112. For example, the one or more data acquisition devices may include sensors, and the data acquisition processor 214 may receive information from data acquisition devices 112 provide data to the application processor. The acquired data may include information indicating the detections performed by the data acquisition devices 112.

In accordance with various aspects described herein, data acquisition devices 112 may include any type of data collection devices deployed within the storage facility 100, which data collection devices may provide measured, sensed, monitored, and/or detected information within the environment of the storage facility. Illustratively, data acquisition devices 112 may include sensors, monitoring tools, RFID readers, barcode scanners, AMRs, storage facility vehicles, deployed within the storage facility to perform various types of operations and functions, some of which may include measuring, sensing, monitoring, and/or detecting their designated location (e.g. respective field of views).

According to various aspects, the acquired data may include sensor raw data, quantized information about the sensed property (e.g., one or more values of the sensed property), or a result of processing the information about the sensed property and/or the sensor raw data. For example, the result of an image acquisition as exemplarily sensing process, may include pixel raw data, the image data based on the raw data, the result of an object recognition based on the image data, a spectral composition, a light intensity value, a distance determined based on the image data, etc. The result of the sensing process may include various types of information about an environment of the sensor, which is based on the sensing process that the sensor may perform. According to various aspects, the result of the sensing process may include information about one or more logic, geometric, kinematic, mechanical, radiometric (e.g., photometric), thermodynamically, electrical, and/or chemical properties of the environment of the sensor, which are determined based on the sensing process that the sensor may perform. Analogously, the type of information may be a logic type, geometric type, kinematic type, mechanical type, radiometric type (e.g., photometric type), thermodynamic type, electric type, and/or chemical type.

Data acquisition devices 112 may include any number of data acquisition devices and components, including sensors, depending on the requirements of a particular application. Sensors may include image acquisition devices, proximity detectors, acoustic sensors, pressure sensors, fingerprint sensors, motion detectors, etc., for providing data about the environment of the storage facility, e.g. the interior of the storage facility. Image acquisition devices may include cameras (e.g., multimodal cameras, standard cameras, digital cameras, video cameras, single-lens reflex cameras, infrared cameras, stereo cameras, depth cameras, RGB cameras, depth cameras, etc.), charge coupling devices (CCDs), or any type of image sensor. Proximity detectors may include radar sensors, light detection and ranging (LIDAR) sensors, mmWave radar sensors, etc. Acoustic sensors may include microphones, sonar sensors, ultrasonic sensors, etc. In some examples data acquisition devices 112 may include weight sensors.

Data acquisition devices 112 may further include Radio-Frequency Identification (RFID) readers configured to read RFID tags. Illustratively, one of the storage facility operations may include deploying RFID tags embedded with unique identifiers to identify items on items. For example, some items may be provided with a corresponding RFID tag in an item arrival procedure. Through processing of the RFID data provided by RFID readers deployed in the storage facility, the control system 200 may obtain information about the item, such as item location, movement history, etc. which may be stored in the item database 250.

Data acquisition devices 112 may further include barcode scanners to detect barcodes or QR codes and send barcode data of detected barcodes or QR codes to the control system 200. Illustratively, barcode scanners may be deployed at various fixed locations within the facility or may be mobile barcode scanners, such as handheld barcode scanner devices, or barcode scanners deployed on AMRs. Through processing of received barcode data, the control system 200 may obtain information about the item such as item location, movement history, item descriptions, etc.

Accordingly, each of the data acquisition devices 112 may be configured to observe a particular type of data at a designated field of view associated to the respective data acquisition device 112 within the storage facility and forward the data to the data acquisition processor 214 in order to provide the control system 200 with an accurate portrayal of the interior of the storage facility. The data acquisition devices 112 may be configured to implement pre-processed sensor data, such as radar target lists or LIDAR target lists, in conjunction with acquired data.

Application processor 216 may be a CPU, and may be configured to handle the layers above the protocol stack, including the transport and application layers. Application processor 216 may be configured to execute various applications and/or programs associated with inventory management within the storage facility at an application layer, such as an operating system (OS), a user interfaces (UI) 206 for supporting user interaction with vehicle 100, and/or various user applications. Application processor 216 may interface with communication processor 218 and act as a source (in the transmit path) and a sink (in the receive path) for user data, such as voice data, audio/video/image data, messaging data, application data, basic Internet/web access data, etc. Application processor 216 may interface with the data acquisition processor 214 to receive sensor data.

In the transmit path, communication processor 218 may therefore receive and process outgoing data provided by application processor 216 according to the layer-specific functions of the protocol stack, and provide the resulting data to digital signal processor 208. Communication processor 218 may then perform physical layer processing on the received data to produce digital baseband samples, which digital signal processor may provide to RF transceiver 108. RF transceiver 108 may then process the digital baseband samples to convert the digital baseband samples to analog RF signals, which RF transceiver 108 may wirelessly transmit via antenna system 106.

In the receive path, RF transceiver 108 may receive analog RF signals from antenna system 106 and process the analog RF signals to obtain digital baseband samples. RF transceiver 108 may provide the digital baseband samples to communication processor 218, which may perform physical layer processing on the digital baseband samples. Communication processor 218 may then provide the resulting data to other processors of the one or more processors 102, which may process the resulting data according to the layer-specific functions of the protocol stack and provide the resulting incoming data to application processor 216. Application processor 216 may then handle the incoming data at the application layer, which can include execution of one or more application programs with the data and/or presentation of the data to a user via a user interface 206. User interfaces 206 may include one or more screens, microphones, mice, touchpads, keyboards, or any other interface providing a mechanism for user input.

In some examples, the communication processor 218 may include a digital signal processor and/or a controller which may direct such communication functionality of the control system 200 according to various communication protocols associated with wired communication protocols, such as universal serial bus (USB) protocol for data communication etc., with various types of devices connected to a port coupled to the communication processor 218.

The communication processor 218 may include a digital signal processor and/or a controller which may direct such communication functionality of vehicle 100 according to the communication protocols associated with one or more radio access networks, and may execute control over antenna system 106 and RF transceiver(s) 108 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness, the configuration of vehicle 100 shown in FIGS. 1 and 2 may depict only a single instance of such components.

The control system 200 may transmit and receive wireless signals with antenna system 106, which may be a single antenna or an antenna array that includes multiple antenna elements. Antenna system 202 may additionally include analog antenna combination and/or beamforming circuitry. In the receive (RX) path, RF transceiver(s) 108 may receive analog radio frequency signals from antenna system 106 and perform analog and digital RF front-end processing on the analog radio frequency signals to produce digital baseband samples (e.g., In-Phase/Quadrature (IQ) samples) to provide to communication processor 218. RF transceiver(s) 108 may include analog and digital reception components including amplifiers (e.g., Low Noise Amplifiers (LNAs)), filters, RF demodulators (e.g., RF IQ demodulators)), and analog-to-digital converters (ADCs), which RF transceiver(s) 108 may utilize to convert the received radio frequency signals to digital baseband samples. In the transmit (TX) path, RF transceiver(s) 108 may receive digital baseband samples from communication processor 218 and perform analog and digital RF front-end processing on the digital baseband samples to produce analog radio frequency signals to provide to antenna system 106 for wireless transmission. RF transceiver(s) 108 may thus include analog and digital transmission components including amplifiers (e.g., Power Amplifiers (PAs), filters, RF modulators (e.g., RF IQ modulators), and digital-to-analog converters (DACs), which RF transceiver(s) 108 may utilize to mix the digital baseband samples received from communication processor 218 and produce the analog radio frequency signals for wireless transmission by antenna system 106. Communication processor 218 may control the radio transmission and reception of RF transceiver(s) 108, including specifying the transmit and receive radio frequencies for operation of RF transceiver(s) 108.

Communication processor 218 may include a baseband modem configured to perform physical layer (PHY, Layer 1) transmission and reception processing to, in the transmit path, prepare outgoing transmit data provided by communication processor 218 for transmission via RF transceiver(s) 108, and, in the receive path, prepare incoming received data provided by RF transceiver(s) 108 for processing by communication processor 218. The baseband modem may include a digital signal processor and/or a controller. The digital signal processor may be configured to perform one or more of error detection, forward error correction encoding/decoding, channel coding, and interleaving, channel modulation/demodulation, physical channel mapping, radio measurement and search, frequency and time synchronization, antenna diversity processing, power control, and weighting, rate matching/de-matching, retransmission processing, interference cancelation, and any other physical layer processing functions. The digital signal processor may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components.

In some aspects, the digital signal processor may include one or more processors configured to retrieve and execute program code that defines control and processing logic for physical layer processing operations. In some aspects, the digital signal processor may execute processing functions with software via the execution of executable instructions. In some aspects, the digital signal processor may include one or more dedicated hardware circuits (e.g., ASICs, FPGAs, and other hardware) that are digitally configured to specific execute processing functions, where the one or more processors of digital signal processor may offload specific processing tasks to these dedicated hardware circuits, which are known as hardware accelerators. Exemplary hardware accelerators can include Fast Fourier Transform (FFT) circuits and encoder/decoder circuits. The digital signal processor's processor and hardware accelerator components may be realized as a coupled integrated circuit in some aspects.

RF transceiver(s) 108 may include separate RF circuitry sections dedicated to different respective radio communication technologies, and/or RF circuitry sections shared between multiple radio communication technologies. Antenna system 106 may include separate antennas dedicated to different respective radio communication technologies, and/or antennas shared between multiple radio communication technologies. Accordingly, antenna system 106, RF transceiver(s) 108, and communication processor 218 can encompass separate and/or shared components dedicated to multiple radio communication technologies.

The control system 200 may be configured to operate according to one or more radio communication technologies. The digital signal processor of the communication processor 218 may be responsible for lower-layer processing functions (e.g., Layer 1/PHY) of the radio communication technologies. In contrast, a controller of the communication processor 218 may be responsible for upper-layer protocol stack functions (e.g., Data Link Layer/Layer 2 and/or Network Layer/Layer 3). The controller may thus be responsible for controlling the radio communication components of vehicle 100 (antenna system 106, RF transceiver(s) 108, position device 114, etc.) in accordance with the communication protocols of each supported radio communication technology, and accordingly may represent the Access Stratum and Non-Access Stratum (NAS) (also encompassing Layer 2 and Layer 3) of each supported radio communication technology. The controller may be structurally embodied as a protocol processor configured to execute protocol stack software (retrieved from a controller memory) and subsequently control the radio communication components of vehicle 100 to transmit and receive communication signals in accordance with the corresponding protocol stack control logic defined in the protocol stack software. The controller may include one or more processors configured to retrieve and execute program code that defines the upper-layer protocol stack logic for one or more radio communication technologies, which can include Data Link Layer/Layer 2 and Network Layer/Layer 3 functions. The controller may be configured to perform both user-plane and control-plane functions to facilitate the transfer of application layer data to and from the control system 200 according to the specific protocols of the supported radio communication technology. User-plane functions can include header compression and encapsulation, security, error checking and correction, channel multiplexing, scheduling, and priority, while control-plane functions may include setup and maintenance of radio bearers. The program code retrieved and executed by the controller of communication processor 218 may include executable instructions that define the logic of such functions.

In some aspects, the control system 200 may be configured to transmit and receive data according to multiple radio communication technologies. Accordingly, in some aspects, one or more of antenna system 106, RF transceiver(s) 108, and communication processor 218 may include separate components or instances dedicated to different radio communication technologies and/or unified components that are shared between different radio communication technologies. For example, in some aspects, multiple controllers of communication processor 218 may be configured to execute multiple protocol stacks, each dedicated to a different radio communication technology and either at the same processor or different processors. In some aspects, multiple digital signal processors of communication processor 218 may include separate processors and/or hardware accelerators that are dedicated to different respective radio communication technologies, and/or one or more processors and/or hardware accelerators that are shared between multiple radio communication technologies. In some aspects, RF transceiver(s) 108 may include separate RF circuitry sections dedicated to different respective radio communication technologies, and/or RF circuitry sections shared between multiple radio communication technologies. In some aspects, antenna system 106 may include separate antennas dedicated to different respective radio communication technologies, and/or antennas shared between multiple radio communication technologies. Accordingly, antenna system 106, RF transceiver(s) 108, and communication processor 218 can encompass separate and/or shared components dedicated to multiple radio communication technologies.

Communication processor 218 may be configured to operate via a first RF transceiver of the one or more RF transceivers(s) 108 according to different desired radio communication protocols or standards. By way of example, communication processor 218 may be configured according to a Short-Range mobile radio communication standard such as, e.g., Bluetooth, Zigbee, and the like first RF transceiver may correspond to the corresponding Short-Range mobile radio communication standard. As another example, communication processor 218 may be configured to operate via a second RF transceiver of the one or more RF transceivers(s) 108 in accordance with a Medium or Wide Range mobile radio communication standard such as, e.g., a 3G (e.g., Universal Mobile Telecommunications System-UMTS), a 4G (e.g., Long Term Evolution-LTE), or a 5G mobile radio communication standard in accordance with corresponding 3GPP (3rd Generation Partnership Project) standards. As a further example, communication processor 218 may be configured to operate via a third RF transceiver of the one or more RF transceivers(s) 108 in accordance with a Wireless Local Area Network communication protocol or standard such as, e.g., in accordance with IEEE 802.11 (e.g., 802.11, 802.11a, 802.11b, 802.11g, 802.11n, 802.11p, 802.11-12, 802.11ac, 802.11ad, 802.11ah, and the like). The one or more RF transceiver(s) 108 may be configured to transmit signals via antenna system 106 over an air interface. The RF transceivers 108 may each have a corresponding antenna element of antenna system 106, or may share an antenna element of the antenna system 106.

The one or more memories 104 may embody a memory component of vehicle 100, such as a hard drive or another such permanent memory device. Although not explicitly depicted in FIGS. 1 and 2, the various other components of vehicle 100, e.g. one or more processors 102, shown in FIGS. 1 and 2 may additionally each include integrated permanent and non-permanent memory components, such as for storing software program code, buffering data, etc.

The antenna system 106 may include a single antenna or multiple antennas. Each of the one or more antennas of antenna system 106 may be placed at a plurality of locations on the vehicle 100 in order to ensure maximum RF coverage. The antennas may include a phased antenna array, a switch-beam antenna array with multiple antenna elements, etc. Antenna system 106 may be configured to operate according to analog and/or digital beamforming schemes in order to maximize signal gains and/or provide levels of information privacy. Antenna system 106 may include separate antennas dedicated to different respective radio communication technologies, and/or antennas shared between multiple radio communication technologies.

The one or more memories 104 may store data, e.g., in a database or in any different format, that may correspond to a map. The map database 204 may include any type of database storing (digital) map data for the machine control system 200. The map database 204 may include data relating to the position, in a reference coordinate system, of physical storage units, physical materials, obstacles, walls, topographic features (e.g., stairs), geographic features, rooms, doors, points of interest, spatial information of a task, docks, etc. within the storage facility. In some aspects, a processor of the one or more processors 102 may download (e.g., some or all) information of the map database 204 over a (e.g., wireless and/or wired) data connection to a communication network (e.g., over a cellular network and/or the Internet, etc.). In some aspects, a processor of the one or more processors 102 may be configured to determine, e.g., form and/or update, (e.g., some or all) information of the map database 204, e.g., based on sensing the environmental condition by the data acquisition devices 112. The map database 204 may include schematics or layouts of the warehouse, specifying the arrangement of physical storage units such as shelves, racks, aisles, storage units, and any other physical structures.

The one or more memories 104 may further store an item database 250 including information about items within the storage facility 100. It is to be considered that any type of information may be stored about each item within the storage facility. Illustratively, information about an item may include i) an item description, such as descriptive information about the item such as name, type, category, or SKU (Stock Keeping Unit); ii) physical item attributes, such as size, dimensions, weight, color, material, and any specific characteristics of the item; iii) location information, such as a designated storage location within the storage facility which may include an indication of a designated aisle, rack, shelf, or specific coordinates and/or current location of the item; iv) current available quantity of the item within the inventory; v) measurement unit used for the item (e.g., pieces, boxes, pallets); vi) information about the cost of the item; vii) storage facility movement history, such as records of item movements, including receipts, transfers, adjustments, and shipments; viii) state information indicating the availability, condition (e.g., new, used, damaged), or status (e.g., reserved, allocated) of the item; ix) designated handling requirements, safety guidelines, or special instructions related to the item; x) unique identifiers, barcodes, or QR codes associated with the item; and/or xi) owner information regarding the supplier or vendor of the item; xi) storage information indicating current or assigned physical storage units to store the item.

In accordance with various aspects described herein, some of the above-mentioned information about an item may be predefined or predetermined, which may be made through computerized operations or by manual inputs of human operators. In some examples, the control system 200 may obtain some of the information about the item 320 based on various techniques perform via data acquisition devices 112 and the data acquisition processor 214 through identifications, estimations, and detections.

Illustratively, the control system 200 may receive sensor data from data acquisition devices 112 exemplarily include image acquisition devices, weight sensors regarding an item within the storage facility environment. Exemplary, a weight sensor may measure the weight of an item and may provide corresponding sensor data via a sensor interface to the control system 200. The data acquisition processor 214 and/or the application processor 216 may process the received sensor data and determine a weight for the item, which may be stored in the item database 250 for that particular item. Additionally, based on sensor data received from image acquisition devices, the data acquisition processor 214 and/or the application processor 216 may perform image processing to determine one or more physical attributes of the item, which may be stored in the item database for that particular item.

In accordance with various aspects described herein, some of the above-mentioned information about an item may be obtained via a cloud services or a wireless wide area network (WWAN). Illustratively, the control system 200 may access an external database over WWAN or cloud services via communication operations performed through the communication processor 218, through which the application processor 216 may perform queries for a designated item to obtain some information about the designated item.

For example, the control system 200 may obtain data from an external database. The external database may store contextual data about an item identified within the storage facility. The contextual data may refer to publicized information, such as the manufacturer of the item, production year of the item, etc. The control system 200 may connect to the external database via an established connection over. The communication processor 218 may receive the contextual data of the item via received radio communication signals by the RF transceiver 108. The received contextual data may be stored in the item database 250. In some aspects, the application processor 216 may, based on the item-related data, perform management-related operations including, but not limited to, determining a priority metric of an item, determining a priority metric of a task related to the item, selecting a storage unit, determining a risk metric for the item, and the like.

The one or more memories 104 may include an operational database 260 including information about operations of the storage facility. Illustratively, operational database may include at least one of i) actor information, such as details about various storage facility entities involved in warehouse operations, such as human operators, AMRs, vehicles, and any other relevant personnel or machines, their identification, roles, qualifications, and permissions; ii) actor location and/or movements, such as information about the whereabouts of these actors within the storage facility, their current positions, paths traveled, zones accessed, and movement history; iii) task assignments including information about the tasks allocated to each actor, such as their assigned tasks, priorities, deadlines, task progress, and completion status; iv) availability and/or utilization information about availability and utilization of resources within the storage facility, such as operational status of equipments, monitoring entities, readiness of human operators for specific tasks, availability of vehicles or AMRs for assignments; v) actor attributes including information about the capabilities, features, and characteristics of the storage facility actors, such as payload capacity of vehicles, lifting capabilities of AMRs, skills or expertise of human operators, and any other relevant attributes influencing their operational roles; vi) transaction history including information about all transactions and movements within the storage facility, such as receipts, transfers, adjustments, shipments, and any changes in inventory status, providing a comprehensive audit trail; vii) performance metrics including various performance indicators and metrics related to warehouse operations, such as picking and packing rates, order fulfillment times, inventory turnover rates, and accuracy metrics; viii) expected or estimated trajectories of items for assigned tasks.

In some examples, information included in at least one of the map database, the item database, and the operational database may be referred to as warehouse management data in this disclosure.

The components illustrated in FIG. 2 may be operatively connected to one another via any appropriate interfaces which may be wired or wireless interfaces. In particular, is some examples, the control system 200 may obtain some of the information described herein for operation of the control system 200 via radio communication through the RF transceivers 108 in accordance with a designated communication protocol with the processing of the communication processor 218. Illustratively, the data acquisition processor 214 may acquire sensor data from data acquisition devices 112 through radio communication. Furthermore, it is appreciated that not all the connections between the components are explicitly shown, and other interfaces between components may be covered within the scope of this disclosure.

The control system 200 may be used to orchestrate activities within the storage facility 100. In that sense, the control system 200 may assign human operators and/or AMRs certain tasks relating to the stored items. As denoted, a task may relate to an interaction with an item, such as transporting the item within the storage facility 100, retrieving the item (e.g. picking up the item), placing the item (e.g. putting down the item), etc. In some aspects, the task may include further operations performed by human operators and/or AMRs.

A task may be represented (e.g., logically) by data (also referred to as task data). A task may refer to one task or a group of multiple tasks, which are related to each other, e.g., contextually or logically related to each other (for example, tasks directed to the transportation of an item, tasks directed to retrieval of the item, and the like). The task data may be a formal representation of the task. Examples of the task data may include: data identifying each task (also referred to as task identifier), data organizing each task (e.g., spatial and/or chronological data), data indicating the criteria under which a task is fulfilled, data indicating goals of each task, data identifying criteria for triggering, terminating, or maintaining a task, etc.

Furthermore, the task data may include a task logic, which logically links tasks, priorities, criteria, conditions, and/or tasks and/or which implements a sequence (e.g., a flow chart), according to which the task is executed. For example, the task logic may organize the task hierarchically, e.g., into hierarchical levels, hierarchical groups, subtasks, and the like. For example, a task may include multiple subtasks on a lower hierarchical level, which may be, but not need to be, prioritized, contextual based, and/or conditional. Viewed from the hierarchical level of the subtask, the subtask may also be referred to as task, and may include, but not need to include, multiple subtasks. For example, the task logic may organize the task in accordance with conditional aspects and/or contextual aspects. For example, the task logic may define conditional tasks, e.g., by defining conditions/requirements to be fulfilled for starting a task performance and/or for ending a task performance.

In an example, the task may refer to accepting one or more items into the storage facility 100 or the task may refer to dispatching one or more items from the storage facility 100. In another example, the task may refer to placing an item into a designated storage unit. Exemplary, the control system 200 may assign a human operator and/or an AMR to place one or more televisions into the one or more storage unit 101, as depicted in FIG. 1. The task assignment may be based on sequential ordering or predefined priorities. The control system 200 may further control the movement of items in scenarios where the items are placed onto a conveyor belt. In that case, the control system 200 may orchestrate the flow-of-items through the storage facility 100.

The control system 200 may facilitate the managing operations provided within the storage facility 100. In some aspects, the storage facility 100 may be an autonomous storage facility not requiring human manager and/or human operators to carry out a task, and instead only AMRs or similar autonomous machines may perform tasks assigned by the control system 200. In that sense, the storage facility 100 may be a self-managing storage facility. In certain aspects where the storage facility is not an autonomous storage facility, human involvement may be restricted to certain actions. Exemplary, the control system 200 may assign only predefined tasks to human operators and utilize AMRs for the specific tasks. The specific tasks, herein, may refer to the tasks requiring a relatively high level of durableness which may fail when performed by human operators whose stamina and focus are typically time-dependent.

The control system 200 may make use of different types of data acquisition devices to acquire information about the items within the storage facility 100. In some examples, the control system 200 may perform real-time monitoring of the interior of the storage facility. The image acquisition devices may vary in size and shape depending on the deployment purpose and/or location. In some aspects, one or more image acquisition devices deployed within the storage facility may be capable of practicing camera-specific movements, such as pan and/or tilt to change the monitored area in order to provide images from different areas to the control system 200. In accordance with various aspects described herein, image acquisition devices may include thermal cameras to provide thermal images of the items to the control system 200 via an interface. The thermal images may be used to identify, detect or predict an item of interest. The thermal cameras may further prove to be useful to provide thermal images, via the interface, of human operators and/or human supervisors to control system 200 as the thermal images may be used to evaluate whether the human participator has an elevated level of anxiety, an increased level of fatigue, and the like.

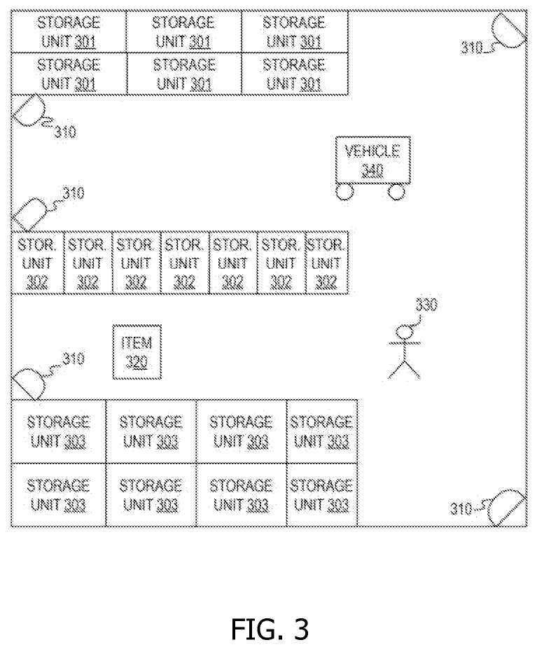

FIG. 3 shows a plurality of image acquisition devices deployed within the storage facility 100 in accordance with various aspects of the disclosure. The image acquisition devices 310 may be identical in shape, size and function in some cases, whereas they may differ in terms of attributes and/or features in other cases. Exemplary, some of the image acquisition devices 310 may be cameras and the rest of them may be other types of image acquisition devices such as thermal cameras. In another example, one or more image acquisition devices 310 may be doom-shaped cameras and one or more other image acquisition devices 310 may be bullet-shaped cameras. The image acquisition devices 310 may monitor the area within their field-of-view in the storage facility 100 represented by the corresponding sensor data associated with the corresponding image acquisition device 310. In that sense, monitoring fields of the image acquisition devices 310 may encompass physical storage units, such as storage units 301, 302, and 303, one or more items stored in the storage units 301, 302, 303, the open field (not explicitly shown in FIG. 2), an item 320 on the open field, a human operator 330 on the open field, a vehicle 340 on the open field, an AMR on the open field, etc. As denoted, the image acquisition devices 310 may include interface to share and/or transmit data to the control system 200. The data may represent surveillance footage of the monitored field.

Storage facilities may traditionally face significant inventory loss due to various reasons like human error, mislabeling, or intentional concealment. As storage facility operations evolve towards autonomous warehouses, which may be expansive and intricate, the challenge of item retrieval may increase exponentially. Noting that storage facilities may vary in size, storage facility operations in large facilities may be particularly challenging, which may often lead to uncertainties about an item's whereabouts, especially whether the item is merely misplaced, incorrectly labeled, or intentionally removed by a human with malicious intent. It may be desirable to allocate monitoring methods within the storage facility to monitor items.

There are various monitoring methods suitable for monitoring and tracking items within storage facilities, aligning with designated capabilities of an IMS, illustratively described for the control system 200. Illustratively, some monitoring methods designated within the storage facility may involve sensors distributed throughout the storage facility. Such sensors, which may be illustratively referred to as data acquisition devices 112, may encompass diverse functionalities, such as image acquisition devices, weight sensors, or any type of sensors illustrated in this disclosure. Through deployed image acquisition devices within the storage facility, the processor 401 may analyze received sensor data from image acquisition devices, illustratively by performing object detection, object identification, and object monitoring techniques, to monitor whereabouts of items and interactions by mobile storage facility actors, such as humans, AMRs, vehicles, with the items. The processor 401 may store monitoring information representing whereabouts of items and the interactions to the memory 402. Accordingly, the control system 200 may perform a real-time monitoring of items within the storage facility, illustratively by capturing visual data of items, open fields, storage units, etc.

Furthermore, the control system 200 may perform RFID tracking and barcode scanning operations, which may through application of storage facility policies, may provide reliable methods for monitoring items with the storage facility. In some cases, the control system 200 may further generate monitoring tasks assigned to human operators and/or AMRs specific to an item or a designated location. In some examples monitoring tasks may be assigned to various types of vehicles suitable for monitoring, such as drones or specialized storage facility vehicles.

In some examples, monitoring methods may include deliberately selecting physical storage units for items to be stored, as some physical storage units may be inherently being monitored through their position and orientation. For example, certain physical storage units may be in clear field of view of image acquisition devices deployed within the storage facility. Some physical storage units may be provided in well-lit areas. Some physical storage units may include built-in sensors, such as weight sensors, which may raise an alarm if an item is removed without knowledge of the control system 200.

It is however to be noted that each monitoring method may require different monitoring resources of the storage facility. Illustratively, such monitoring resources may include computing resources to perform processing for computer vision techniques for object identification, object tracking and object detection, processing of received sensor data, deployment of data acquisition devices 112 within the facility, implementation of policies for RFID scanning and/or barcode scanning tasks, assignment of tasks for deployment of human operators, AMRs, vehicles, number of available inherently monitored physical storage units etc. In particular in a scenario in which tens or hundreds of items may be on transport and thousands of items may be stationed on storage units at an instance of time, monitoring items may be a challenging task considering limitations of the control system 200.

Each monitoring operation of an item may be designated by a task which allocates designated monitoring resources for the monitoring. Based on the designated task of monitoring, the control system 200 may communicate with monitoring entities that are going to perform the monitoring associated with the task.

Illustratively, a designated monitoring task indicating a monitoring of an item by computer vision techniques at a designated location may be associated with monitoring entities including image acquisition devices having the designated location in their field of view, computing resources to process sensor data received from those image acquisition devices, and communication resources to establish communication the image acquisition devices and the computing resources.

In accordance with various aspects described herein, the control system 200 may associate metrics for items within the storage facility, which each metric associated with an item may represent a likelihood of the item becoming lost within the storage facility. Based on the associated metric, the control system 200 may determine monitoring only certain items within the storage facility and allocate monitoring resources to track those items.

In accordance with various aspects described herein, the control system 200 may determine the metric based on the information stored in the item database 250 by considering various features described in the item database 250 for the item. In some aspects, the control system 200 may determine the metric based on previously tracked items within the storage facility and maintained statistics associated with lost items in the past.

In accordance with various aspects described herein, the control system 200 may employ external databases through cloud services and WWAN to enhance the information about the item for determination of the metric. In particular, the control system 200 may obtain contextual data about the item through queries to external databases.

It is to be noted that aspects described herein are to be illustrated for an apparatus of the control system including the one or more processors 102 and the one or more memories 104, which are referred to as the processor and the memory respectively for brevity. The skilled person would recognize that the many aspects described herein may be particularly directed to the processor and the memory of the control system 200, and may be compliant with any control system through designated interfaces as described herein.

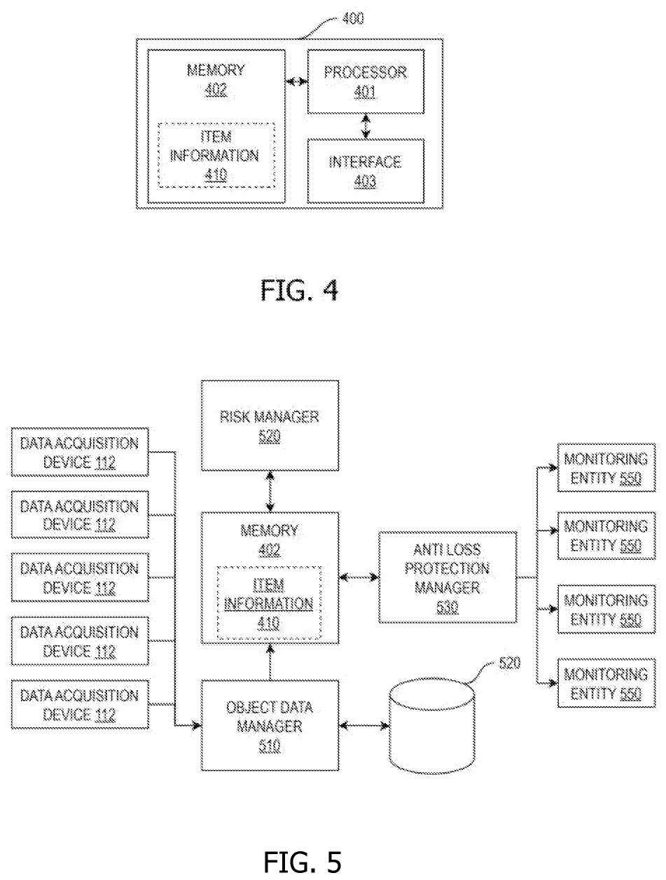

FIG. 4 shows an illustrative example of an apparatus. The apparatus may be suitable for a control system (e.g. the control system). The apparatus may include a processor 401 (e.g. the one or more processor 102), a memory (e.g. the one or more memories 104) configured to store item information 410 (e.g. the item database 250) including information about items within the warehouse, and an interface 403.

The processor 401 may include one or more processing means, the processor may include a central processing unit (CPU), a graphics processing unit (GPU), a hardware acceleration unit (e.g. one or more dedicated hardware accelerator circuits (e.g., ASICs, FPGAs, and other hardware)), a neuromorphic chip, and/or a controller. The processor 401 may be implemented in one processing unit, e.g. a system on chip (SOC), or a processor. In some examples the processor 401 may include one or more cores as computation units, an arithmetic logic unit, a control unit, a storage unit, a plurality of registers. The processor 401 illustrated herein may include multiple processors, as illustratively described in accordance with FIG. 2.

The interface 403 may be configured to receive data of data acquisition devices (e.g. data acquisition devices 112) deployed in a storage facility. Received data may include information representative of at least one of sensing, measurement, detection, monitoring performed within the storage facility. For example, received data may include sensor data provided by a variety of sensors, the sensor data representing one or more sensor detections of the interior of the storage facility. Received data may further include RFID readings, barcode scans, measurements, AMR messages, storage facility messages, etc.

In an example, the interface 403 may be a communication interface (e.g. including RF transceiver 108 and the antenna system 106) to receive sensor data encoded in packets of a communication protocol. In an example, the interface 403 may be designated interfaces couplable to corresponding data acquisition devices. Data transmission between the sensors and the communication system 450 may be carried out via wireless connection (e.g., WLAN). or via a wired connection (e.g., USB connection) through a port (e.g., USB port).

The memory 402 may store an item database (e.g. the item database 250). The item database may include information about items within the storage facility, some of which have been described in this disclosure. Traditionally, for a particular item, first entry of information within the memory 402 may begin with the item entering into the storage facility, or an order information about the item being expected within the storage facility for entering. Illustratively, through automatic computerized operations, some of the information about the item may be stored within the item database, such as automatic parsing of the order information, first RFID reading or barcode scan to the item database. In some examples, a human operator may enter some of the information about the item through a user interface (e.g. the user interfaces 206).

In order to maintain the information about items updated to reflect current situation and/or conditions about items and to enhance obtained knowledge about the item, the processor 401 may log detections and interactions about items identified by data acquisition devices into the item database. Furthermore, the processor 401 may determine a corresponding metric for each item of the items, which the corresponding metric represents a likelihood of the item becoming lost within the storage facility. The processor 401 may determine each metric of an item based on information stored in the item database, illustratively based on information about the respective item. Based on a determined metric for a corresponding item, the processor 401 may determine a monitoring method to monitor the corresponding item within the facility and may instruct designated monitoring entities for the determined monitoring method to monitor the corresponding item within the facility.

Aspects described herein is illustrated according to one particular item (e.g. the item 320) as an example for brevity, however it is to be noted the apparatus 400 may perform these aspects for multiple items, a designated group of items, or all items within the storage facility, illustratively for each item having item information in the item database that may be used to identify the item (e.g. a unique identifier), which the items may be items having different characterizations or items having the same characterizations. In this context, when aspects described for one particular item, other items within the storage facility may be referred to as other items or further items.

FIG. 5 shows an illustrative example of schematic representation of a storage facility control system in accordance with various aspects of this disclosure. The illustration includes an object data manager (ODM) 510, a risk manager (RM) 520 and an anti-loss protection manager (APM) 530, which may be distinct units specified for the functions described herein and/or which may be implemented by various components of a control system (e.g. the control system) including a processor (e.g. the one or more processors 102, the processor 401) and the memory 402 including an item database (e.g. item database 250). In the latter, the skilled person would recognize that the depicted units are provided to explain various operations that the processor (e.g. the one or more processors 102, the processor 401) may be configured to perform. The ODM 510 may be communicatively coupled to the data acquisition devices 112 provided within the storage facility for monitoring of the storage facility. Complementing to aspects described in accordance with FIG. 2, the ODM 510 may include data acquisition processor 214.

The ODM 510 may obtain data from the data acquisition devices 112. As described, the data acquisition devices 112 may include any type of data collection devices deployed within the storage facility 100, which data collection devices may provide measured, sensed, monitored, and/or detected information within the environment of the storage facility. In this illustrative example, the data acquisition devices 112 may include image acquisition devices, such as cameras, LIDARs, weight sensors, proximity sensors, motion detectors, thermal cameras, wearable devices deployed on human operators within the facility, biometric sensors, and the like.

The ODM 510 may receive monitoring data (e.g. sensor data) from data acquisition devices 112 and identify items based on received monitoring data. Identification of items may include commonly known methods, such as object recognition, illustratively in which the ODM 510 identifies the item based on sensor data received from image acquisition devices and information stored in the item database. For example, when the item goes through an item arrival procedure to enter into the storage facility, the ODM 510 may store visual data representing the item in the item database and identify the item based on the stored visual data of the item. Additionally, or alternatively, the ODM 510 may identify the item based on combination of received monitoring data, illustratively the item may be scanned by a barcode scanner at a designated location and the ODM 510 may identify the item based on sensor data received from image acquisition devices having their field of view toward to the designated location. The ODM 510 may further identify the item based on received monitoring data which may include an identifier indicating the item.

The ODM 510 may store information about each identified item to the memory 402 within the item database. Accordingly, each identified item within the storage facility may be associated with item information 410 about the item stored in the memory 402. The item information 410 may include various types of information about the item, some of which have been described in this disclosure. For example, the item information 410 for an item may include location information that may represent one or more locations of the item at different instances of time. The item information 410 may include a measured or designated weight of the item. The item information 410 may include a designated price or financial cost of the item. The item information 410 may include information about physical attributes of the item.

Furthermore, the ODM 510 may perform queries about an identified item to an external database or a cloud service 520 to obtain contextual information about the item. For example, when an item is identified, illustratively at the item arrival procedure, the ODM 510 may obtain information about the item which may characterize the item enough to be queried through public data sources. For example, for an identified item, the item information 410 may include a publicly known identifier, such as item name and/or item description and/or an SKU number and/or a barcode number. The ODM 510 may perform a query to obtain information about the publicly known identifier from the external database and/or cloud service 520. The ODM 510 may receive information about the publicly known identifier from the external database 520 in response to the performed query and store the received information as the item information 410 of the identified item.

Illustratively, the ODM 510 may store any type of contextual information received from the external database and/or the cloud service 520. For example, the contextual information may also include an item description, an item type, barcodes or QR codes designated for the item, supplier of the item, manufacturer of the item, physical item attributes, etc. In some examples, the contextual information may further include information representing potential desirability and/or cost of the item. Such contextual information may illustratively include a sales price of the item, average sales price of the item, average review scores of the item, consumer reviews for the item, etc. The ODM 510 may store received contextual information as the item information 410 into the memory 402.

Accordingly, the ODM 510 may build and maintain extensive knowledge about the item during the time frame in which the item is considered to be within the storage facility, illustrative from the item arrival procedure through which items are entered into the storage facility from the perspective of the control system until item departure procedure through which items are considered to have left the storage facility.

It is to be noted that the ODM 510 may build up the item information 410 about the item continuously with interactions to the item. Illustratively, at a first instance of time a first data acquisition device may send data about a scanned barcode of the item and the ODM 510 may store barcode information within the item information 410. At a second instance of time, a second data acquisition device may send visual data representing the item and the ODM 510 may store the visual data within the item information 410. At a third instance of time, a third data acquisition device may send weight information of the item and the ODM 510 may store the weight information within the item information 410.

The RM 520 may be configured to determine metrics for identified items (e.g. for each identified item) within the storage facility. Each determined metric is for an identified item and may represent the likelihood of the identified item becoming lost within the storage facility. The RM 520 may determine the metrics based on stored item information 410 within the item database. Illustratively, each metric may be a score (e.g. a normalized score) to indicate the likelihood of the item becoming lost. Any type of metric may be used to indicate the likelihood. In some examples, the metric can be binary representing whether the item is likely to become lost or not likely to become lost. The metric can be a number, a fraction, or a decimal. For example, a determined metric may represent an estimated potential monetary loss that is based on the likelihood of the item becoming lost within the environment.

The RM 520 may determine the metric based on a designated mapping operation representing a mathematical function (e.g. predefined mathematical equation) including one or more parameters that are based on the stored item information 410. In particular, the one or more parameters may be based on the contextual information about the item received from an external database and/or cloud services 520 within the item information 410, based on the monitoring data received from data acquisition devices 102 within the item information 410, and based on further information within the item information 410 stored during storage facility operations by the control system for inventory management such as item arrival time of the item, whether the item is going to be stocked in the storage facility, whether the item is to be shipped individually or in bulk, etc.

For example, one of the parameters may be item size stored in the item information 410 that may represent the size of the item (e.g. size of the packaging of the content), and the mapping operation may be configured to reduce the likelihood as the item size increases, as illustratively the smaller items are most likely to be lost. Another parameter may be weight of the item, and the mapping operation may be configured to reduce the likelihood, at least for weights above a designated weight value, as the heavier items may not be likely to be lost.

Another one or more parameters may be information representing potential desirability and/or cost of the item provided by the contextual information. The one or more parameters may include at least one of a sales prices, an average sales price, average review scores of the item, and/or consumer reviews for the item and the mapping operation may be configured to increase the likelihood of becoming lost as the desirability and/or cost of the item increases. In some examples, the RM 520 may estimate desirability of the item based on identified keywords from the consumer reviews. Illustratively, predefined keywords may increase or decrease the desirability of the item.

In some examples, the RM 520 may perform estimations to determine a parameter of the one or more parameters of the mapping operation. The RM 520 may perform the estimations based on the item information 410, the item database, and/or other data stored by the control system. In some aspects, the item database may not only include information about items within the storage facility, but may further include information about items that have been arrived and left, which may be referred to as past items in this disclosure. During regular operations, the ODM 510 may have obtained item information about the past items as described herein and store in the item database.

For example, a parameter may be based on past operations performed within the storage facility, illustratively past item storage and/or past item transport operations. For example, the parameters may be based on the number of lost items in the past according to the information database. The parameter may illustratively be a lost item ratio (i.e. a number items lost in the past vs. total number of items). A parameter may be based past operations performed within the storage facility for items having the same characteristics with the identified item, such as the same item description, the same SKU number, the same item type or category, illustratively based on the number of lost items in the past having the same characteristics with the identified item. The mapping operation may be configured to increase the likelihood of becoming lost as the number of lost items in the past increases. The RM 520 may perform estimations and calculations to obtain these parameters.

For example, a parameter may be based on similarities of the identified item to lost items in the past. For this purpose, the RM 520 may estimate a similarity score based on information about the identified item and information about lost items in the past from the item database, representing the similarity between the identified item to lost items in the past. The mapping operation may be configured to increase the likelihood of becoming lost as the similarity increases.

Another parameter may be a traverse path for the identified item to be transported within the storage facility. For example, the RM 520 may estimate certain traverse paths and/or locations within the storage facility may have been associated with an increase of likelihood of items getting lost. Illustratively, certain items transported via certain paths may get dropped unknowingly by AMRs, human operators, and/or storage facility vehicles. Exemplarily, the path may have a type of anomaly. The RM 520 may identify such paths based on the item database, and the mapping operation may be configured to increase the likelihood of becoming lost if the identified item is estimated to be transported with one of identified paths. The RM 520 may illustratively learn this behavior based on the item database also including information about lost items.

In accordance with various aspects described for the RM 520, it is to be noted that, even if the identified item is newly introduced to the item database, the RM 520 may determine its metric based on existing items stored in the item database and can be proactive in estimating their metric based on previous similar products. For this purpose, the RM 520 may use trained artificial intelligence and/or machine learning models (AI/ML) to learn such behaviors and perform inferences based on item information stored in the memory about the identified item and optionally about other items (e.g. items lost in the past) to determine parameters or the metric).

Another parameter may be based on storage facility actors interacting or estimated to interact with the identified item. For example, each storage facility actor may have an associated entity score indicating the likelihood of losing an item (e.g. dropping an item, misplacing an item, etc.). Illustratively, a specific AMR may be identified to drop lightweight items if they are not secured well on a pallet when turning sharp corners. The mapping operation may be configured to increase the likelihood of the item becoming lost if the RM 520 estimates that the specific AMR is to be interact with the item. It is to be noted that in this case, the combination of the item, the interacting storage facility actor and stock management steps may be assessed with a learned risk level. The RM 520 may identify the combination and provide information indicating the combination to the, which the RM 520 may provide to the APM 530, so that the APM 530 may take a mitigating action by changing assigned tasks to break down the combination.

In some examples, the RM 520 may determine risk factors to the storage facility actors. A risk factor of a storage facility actor may represent a likelihood of a malicious behavior of the storage facility actor in the context of losing items. A malicious behavior may include a human operator hiding an item in order to remove the item unlawfully from the storage facility. A malicious behavior may include an AMR being hacked and illustratively dropping items due to being hacked deliberately or routing items to an area where the items can be stolen. A parameter may be based on the risk factors interacting or estimated to be interact with the item, and the mapping operation may be configured to increase the likelihood of the item being lost as one of the risk factors of interacting or estimated to be interacting storage facility actors increases.

For this purpose, the RM 520 may access data provided by data acquisition devices 112 (or analysis performed by the ODM 510) and analyze accessed data for designated markers. For example, the RM 520 may estimate a risk factor for a human operator by monitoring facial expressions, body language, and unusual actions that deviate from regular operational pattern. For example, changes in facial expressions may indicate a heightened anxiety level. For example, an anomaly detector or a trained AI/ML may analyze accessed data in real-time by detecting anomalies, such as frequent visits to certain physical storage units, extended periods spent out of sight, or unusual movements that may be indicative of human being hiding or attempting to steal an item.

The analysis may further be based on wearables worn by the human operator. Illustratively, wearables may include a smart hard hat or safety vest embedded with biometric sensors. The RM 520 may also provide the data received from the wearables to the anomaly detector or the trained AI/ML for detecting anomalies. Based on detected number of anomalies, the RM 520 may determine the risk factor of the human operator.

Illustratively, the RM 520 may obtain visual data from image acquisition devices and identify the human operator within the visual data. The RM 520 may be configured to execute an image processing algorithm to recognize human faces, gestures, and body language within the visual data of a designated period of time. The image processing algorithm may be configured to distinguish a normal behavior and anomaly behavior from the visual data of the designated period of time. Illustratively, anomaly behavior may include deviations from the normal behavior, such as nervous gestures, lingering in unexpected areas, repeated visits to certain areas, etc.

In an example, the RM 520 may estimate a risk factor for an AMR based on a difference between observed behavior or actions of the AMR and expected behavior or actions of the AMR. The RM 520 may obtain the information required to analyze the difference from the control system. In some examples, if the RM 520 identifies a high risk score for the AMR, the RM 520 may inform the APM 530 by sending an information indicating the identification of the high risk score, so that the APM 530 may take a mitigating action, such as increasing the security level in an identified area to collect more data about storage facility actors and their behavior.

In accordance with provided examples, the RM 520 may determine the metrics for identified items and store determined metrics presenting likelihood of identified items being lost in the memory 402 as the item information associated with the identified items. It is to be noted that the RM 520 may perform this operation in real-time and continuously, so that metrics determined for identified items may change in time as the ODM 510 provides more information about identified items or update previously provided information about identified items.

The APM 530 may access the item database stored in the memory 402 and determine various actions based on determined metrics of identified items stored in the item database. The determined actions by the APM 530 may be associated with the monitoring of items within the storage facility, and/or the protection of items within the storage facility, and/or retrieval of items considered to be lost within the storage facility.

In accordance with various aspects described herein, the APM 530 may select a monitoring method for an identified item based on the determined metric for the identified item. Based on the selected monitoring method, the APM 530 may allocate monitoring resources and/or assign tasks to the monitoring entities 550.

In some examples, the APM 530 may maintain a list of items to be monitored, which may be referred to as a tracking list based on the determined metrics stored in the item database. Illustratively, the APM 530 may monitor the determined metrics stored in the item database and include items based on a predetermined threshold. The threshold may be a fixed threshold, or may be based on available monitoring resources of the storage facility. For example, the APM 530 may include items associated with determined metrics greater than the predetermined threshold in the tracking list, which may be referred to as tracked items. It is to be noted that due to continuous operation of the ODM 510 to update the item database, and the nature of the RM 520 being dynamically determining metrics of identified items, the tracking list may also be a dynamic list changing in time. The metric may also be configured to be determined to minimize the monetary loss. It is to be noted that in some examples the RM 520 may determine metrics according to item information about the past items, trends, seasonality, social media, and other data by determining the lifetime of an item in the storage facility before the item is expected to be shipped elsewhere to identify whether this item should be protected and for a duration of the protection.

The APM 530 may determine available monitoring resources based on the item database and warehouse management data that may indicate all monitoring resources of the storage facility. For example, the APM 530 may identify occupied physical storage units from the storage information in the item database and based on information about all monitoring resources, the APM 530 may identify available inherently monitored physical storage units as available monitoring resources. Furthermore, the APM 530 may determine available computing resources usable as monitoring resources based on information received from the operating system of the control system. The APM 530 may further obtain information about available AMRs, human operators, storage facility vehicles suitable for monitoring tasks based on information within the operational database and their resources.

Based on determined available monitoring resources, the APM 530 may allocate monitoring resources to the tracked items. In some examples, the APM 530 may allocate monitoring resources for a tracked item based on the available monitoring resources and the item information about the tracked item. For example, for small but valuable tracked items, the APM 530 may assign physical storage units near each other in a well-lit area that may be equipped with weight sensors and image acquisition devices, assuming that the conditions of those physical storage units may deter any theft.

For this purpose, the APM 530 may select tracked items having dimensions and/or sizes below a designated dimension and/or size and having designated prices above a predefined price value. Further, the APM 530 may identify physical storage resources according to information stored in the map database and/or the operational database by identifying inherently monitored physical storage units in a well-lit area. The APM 530 may assign identified inherently monitored physical storage units to the selected tracked items. If necessary, the APM 530 may generate tasks for transportation of the selected items to the assigned physical storage units.

In some examples, the APM 530 may generate tasks for deploying available tracking chips on the tracked items. The APM 530 may further determine to reduce the allocated monitoring resources or the tracked items. Illustratively, if the APM 530 identifies that a tracked item having a deployed tracking chip is already being monitored sufficiently, the APM 530 may generate a task to instruct the tracking chip to operate in a low power mode to conserve the power of the tracking chip.

In some examples, the APM 530 may generate tasks for deploying human operators and/or AMRs, and/or vehicles having monitoring ability such as drones, to monitor a tracked item. For example, if a designated number of tracked items are gathered on physical storage units positioned near each other, the APM 530 may generate a task for the corresponding storage facility actor having monitoring ability to the area to monitor the identified locations of the physical storage units.

The APM 530 may allocate monitoring resources based on designated monitoring priorities. For example, the priorities may be designated between owners of the items, the owner being the owner of the order of storing the item such as a retailer, an item owner, or a vendor. Illustratively, service level agreements made with designated owners may impose a prioritization of monitoring resources. Accordingly, based on the owner information within the item database, the APM 530 may allocate monitoring resources to tracked items, such that more or better monitoring resources are allocated to prioritized owners. Illustratively, if there are a lack of monitoring resources, the APM 530 may generate tasks to allocate previously allocated monitoring resources of some tracked items associated with a lower priority to tracked items associated with a higher priority.

Furthermore, in case of a lack of resources, the APM 530 may generate tasks to transport some of tracked items in a designated location and assign a storage facility actor having monitoring ability to the designated location until an availability of monitoring resources or retrieval of the items. In some examples, the APM 530 may generate tasks to deploy monitoring resources of another storage facility and/or generate tasks for obtaining further monitoring resources (e.g. new drones, image acquisition devices, sensors, chips having been brought to the storage facility). In some examples, the APM 530 may generate such tasks in response to a validity of new service level agreements. Illustratively, when such service level agreements are signed with owners, the APM 530 may place orders of further monitoring resources to fulfill the commitment once items of the owners arrive and until they leave the storage facility.

In some examples, the APM 530 may further generate tasks to identify misplaced and/or lost items within the storage facility. Illustratively in response to the number of lost items exceeding a designated quantity, the APM 530 may generate tasks for storage facility actors having monitoring abilities to scan the storage facility for misplaced items. For example, a drone may scan each encountered item to identify lost items. The drone may send information about scanned items and the APM 530 may check the item database to identify if scanned item is lost. In response to an identification of a lost scanned item, the APM 530 may generate a task for retrieval of the lost item.

In accordance with various aspects of this disclosure, the control system may handle incoming and outgoing inventory of items, which is also referred to as item arrival procedure and item departure procedure. Furthermore, through provided monitoring by employment of data acquisition devices and designated storage facility operational policies, items accepted within the storage facility may be tracked at certain points of interests for documentation of whereabouts of items within the storage facility.

Although traditional item tracking methods may be considered as sufficient, occasional discrepancies may arise resulting in issues with respect to the accuracy of location of items. Illustratively, human operators tasked to interact with items may relocate them without performing necessity tasks according to designated operational policies, which may include updating the location of the item for the control system 200. Furthermore, AMRs may occasionally grasp incorrect items, which may contribute the inaccuracies of item locations. Moreover, there may be unforeseen events during transportation, such as items inadvertently falling, which may further complicate the accuracy of inventory location within the control system 200.

Illustratively, the control system 200 may orchestrate items and tasks related to the items within the storage facility 100 as the control system 200 may store information about the storage position of a corresponding item in the item database 250. In some cases, storage information and/or the location information stored in the item database for the item may be inaccurate. In some examples, there may be various causes of such inaccuracies, such as a human engaging in a fraudulent activity or causing an intended/unintended movement of the item without reporting the action to the control system 200, and the like. In some cases, an AMR may drop the item when relocating the item to another position in accordance with an assigned task. In some examples, an AMR may pick an item different from the item identified by a corresponding task. In that case, the AMR may end up with relocating and/or transporting the wrong item. Therefore, due to inaccuracies at the storage information and/or location information within the item database, the item may be lost within the storage facility 100. It may be desirable to identify such instances and provide countermeasures for security of the items within the storage facility 100.

Typically, dealing with missing items within the storage facility 100 may require a human intervention. Exemplary, a human operator may need to investigate the item database about a missing item to locate the item. Illustratively, the human operator may investigate intended destination, original storage position, and the like. This manual inspection may not be time efficient and may be costly due to occupying of the human operator. It may be desirable to address these issues. The process may rely on information provided by readily available resources with data acquisition capabilities within the storage facility 100, illustratively via data acquisition devices 112 including image acquisition devices and other sensors. In some aspects, additional resources specifically designed and allocated for the item tracking may be used as additional or alternative tools to the readily available resources within the storage facility 100.

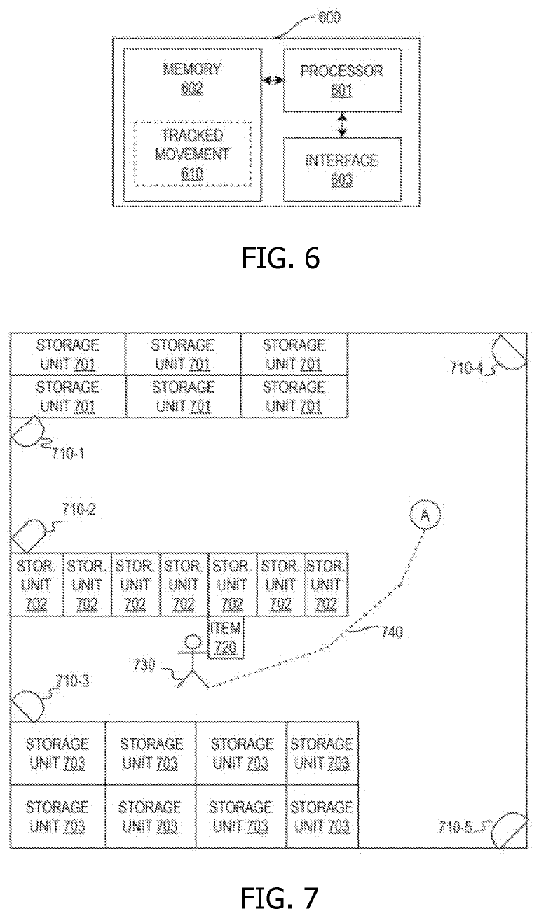

FIG. 6 shows an illustrative example of an apparatus. The apparatus may be suitable for a control system (e.g. the control system). The apparatus may include a processor 601 (e.g. the one or more processor 102), a memory (e.g. the one or more memories 104) configured to store item information 610 (e.g. the item database 250) including information about items within the storage facility, and an interface 603.

The processor 601 may include one or more processing means, the processor may include a central processing unit (CPU), a graphics processing unit (GPU), a hardware acceleration unit (e.g. one or more dedicated hardware accelerator circuits (e.g., ASICs, FPGAs, and other hardware)), a neuromorphic chip, and/or a controller. The processor 601 may be implemented in one processing unit, e.g. a system on chip (SOC), or a processor. In some examples the processor 601 may include one or more cores as computation units, an arithmetic logic unit, a control unit, a storage unit, a plurality of registers. The processor 601 illustrated herein may include multiple processors, as illustratively described in accordance with FIG. 2.

The interface 603 may be configured to receive data of data acquisition devices (e.g. data acquisition devices 112) deployed in a storage facility. Received data may include information representative of at least one of sensing, measurement, detection, monitoring performed within the storage facility. For example, received data may include sensor data provided by a variety of sensors, the sensor data representing one or more sensor detections of the interior of the storage facility. Received data may further include RFID readings, barcode scans, measurements, AMR messages, storage facility messages, etc.

In an example, the interface 603 may be a communication interface (e.g. including RF transceiver 108 and the antenna system 106) to receive sensor data encoded in packets of a communication protocol. In an example, the interface 603 may be designated interfaces couplable to corresponding data acquisition devices. Data transmission between the sensors and the communication system 650 may be carried out via wireless connection (e.g., WLAN). or via a wired connection (e.g., USB connection) through a port (e.g., USB port).

The memory 602 may store an item database (e.g. the item database 250). The item database may include information about items within the storage facility, some of which have been described in this disclosure. Traditionally, for a particular item, first entry of information within the memory 602 may begin with the item entering into the storage facility, or an order information about the item being expected within the storage facility for entering. Illustratively, through automatic computerized operations, some of the information about the item may be stored within the item database, such as automatic parsing of the order information, first RFID reading or barcode scan to the item database. In some examples, a human operator may enter some of the information about the item through a user interface (e.g. the user interfaces 206).

In order to maintain the information about items updated to reflect current situation and/or conditions about items and to enhance obtained knowledge about the item, the processor 601 may log detections and interactions about items identified by data acquisition devices into the item database. Furthermore, the processor 601 may determine a corresponding metric for each item of the items, which the corresponding metric represents a likelihood of the item becoming lost within the storage facility. The processor 601 may determine each metric of an item based on information stored in the item database, illustratively based on information about the respective item. Based on a determined metric for a corresponding item, the processor 601 may determine a monitoring method to monitor the corresponding item within the facility and may instruct designated monitoring entities for the determined monitoring method to monitor the corresponding item within the facility.

Aspects described herein is illustrated according to one particular item (e.g. the item 320) as an example for brevity, however it is to be noted the apparatus 600 may perform these aspects for multiple items, a designated group of items, or all items within the storage facility, illustratively for each item having item information in the item database that may be used to identify the item (e.g. a unique identifier), which the items may be items having different characterizations or items having the same characterizations. In this context, when aspects described for one particular item, other items within the storage facility may be referred to as other items or further items.

The processor 601 may obtain data received from the data acquisition devices 112. As described, the data acquisition devices 112 may include any type of data collection devices deployed within the storage facility 100, which data collection devices may provide measured, sensed, monitored, and/or detected information within the environment of the storage facility. In this illustrative example, the data acquisition devices 112 may include image acquisition devices, such as cameras, LIDARs, weight sensors, proximity sensors, motion detectors, thermal cameras, wearable devices deployed on human operators within the facility, biometric sensors, and the like.

The processor 601 may receive monitoring data (e.g. sensor data) from data acquisition devices 112 and identify items based on received monitoring data. Identification of items may include commonly known methods, such as object recognition, illustratively in which the processor 601 identifies the item based on sensor data received from image acquisition devices and information stored in the item database. For example, when the item goes through an item arrival procedure to enter the storage facility, the processor 601 may store visual data representing the item in the item database and identify the item based on the stored visual data of the item. Additionally, or alternatively, the processor 601 may identify the item based on combination of received monitoring data, illustratively the item may be scanned by a barcode scanner at a designated location and the processor 601 may identify the item based on sensor data received from image acquisition devices having their field of view toward to the designated location. The processor 601 may further identify the item based on received monitoring data which may include an identifier indicating the item.

In accordance with various aspects described herein, the data acquisition devices 112 may include image acquisition devices deployed within the storage facility environment suitable for item tracking within the storage facility. Illustratively, image acquisition devices are deployed to have open fields and physical storage units of the storage facility within their field of view for a comprehensive coverage of critical areas. The image acquisition devices may be configured to operate continuously, recording activities and movements within the storage facility environment and may capture a real-time footage of the interior of the storage facility and providing video streams as captured visual data to the control system.

The processor 601 may access video streams and analyze captured visual data from multiple image acquisition devices to identify items within the captured visual data and track movement of identified items. There are various computer vision techniques, and the processor 601 may implement any known computer vision techniques to identify items within the captured visual data and track movement of identified items. In some examples, the processor 601 may store the captured visual data in the memory 602, which may be for offline analysis of the captured visual data.

Illustratively, the processor 601 may perform a preprocessing on captured visual data to enhance captured images (i.e. images of the video stream) for object detection and tracking algorithms. The preprocessing may include noise reduction, contrast adjustment, and sharpening to optimize the captured visual data for analysis.

The processor 601 may further perform object detection techniques to identify items from the preprocessed visual data. Illustratively, the object detection techniques may include feature extraction to extract various features from the preprocessed visual data, which may identify distinct characteristics of items such as their shape, their physical dimensions, their color, their texture, visual patterns on items like barcodes, labels, or QR codes.

The processor 601 may perform the object detection techniques using trained AI/MLs for this purpose. For example, trained AI/MLs may be configured to utilize designated computer vision algorithm, such as Convolutional Neural Networks (CNNs) and/or object detection frameworks like YOLO (You Only Look Once) or single short multibox detector to detect and identify items from the preprocessed visual data.

In some examples, the processor 601 may feed information obtained from the item database to the object detection techniques. In some examples, such information may include physical item attributes of items, information about barcodes, QR codes, and/or labels of items. Accordingly, the processor 601 may identify items through objects detected by the objection detection techniques and information provided in the item database. In other words, the processor 601 may map identified objects to items based on information stored in the item database.

In some examples, the processor 601 may identify an item according to other identified items within the field of view of the corresponding image acquisition device capturing the corresponding preprocessed visual data. For example, the processor 601 may feed information about item dimensions that are in their corresponding physical storage units in the scene represented by preprocessed visual data.

In some examples, the object detection techniques performed by the processor 601 may include localization. Accordingly, the processor 601 may determine location and boundaries of identified objects from the preprocessed visual data and may enclose objects in bounding boxes.

The processor 601 may further perform designated tracking algorithms to track movement of identified objects. Tracking algorithms may be configured to analyze how a detected object (i.e. item) moves within the sequence of preprocessed visual data. Based on the analysis, the processor 601 may determine trajectories of identified items. The processor 601 may further determine a speed and a direction of movement (e.g. a heading) associated with a determined trajectory. Such tracking algorithms may include optical flow techniques.

FIG. 7 shows an illustrative example of a storage facility environment. In that sense, prior to removal, the control system may or may not assign a task relating to removal, such as a transportation and/or a relocation, for the item 720. Additionally, the human 730 may not provide relevant information to the control system by creating an entry to the database about the removal of the item 730, informing the control system about the removal of the item 720.

Traditionally, the control system may catch such an action with the item tracking described above, however the item may have been located in an occluded region of visual data or may be located in a blind spot without any image acquisition device coverage. This instance may result in the item 720 getting lost or missing within the storage facility 100.

As depicted in FIG. 7, the human 730 may pick up the item 720 (i.e., tracked item) from its original storage position, exemplary from one of the storage units 702 to take the item 720 to another point, such as point A. The storage unit 702 in which the item 720 is stored may have a unique shelf identifier. The human 730 may follow a movement path such as the path 740. Exemplary, the camera 710-3 may monitor the item 720 resting at its original storage position as the corresponding storage unit 702 may be in the field-of-view of the camera 710-3. The camera may further monitor the area covering a part of the path 740. The processor 601 may receive the sensor data from the camera 710-3 as an input data for the tracking algorithm. Illustratively, other cameras (e.g. camera 710-5) may further monitor an area on which a part of the path 740 resides. In that sense, multiple cameras may monitor the partially overlapping, overlapping or non-overlapping areas associated with the path 740 to provide sensor data to the control system.

The processor 601 may receive sensor data from one or more cameras as input data to execute the tracking algorithm. From the item database, the processor 601 may further receive information about items within the field of view of one or more cameras monitoring the original storage position of the item 720. The contextual and/or metadata about items may improve the result of algorithm executed by the processor 601. Exemplary, the processor 601 may receive item information about one or more items to match the item 720 in order to determine the item 720. Illustratively, when executed by the processor 601, the algorithm may generate an output including a likelihood of a type for the item 720, suggesting one or more probabilities of one or more item types (e.g., a wristwatch, a smartphone, etc.).

In some cases, an AMR (or another autonomous machine) may drop an item as it transports and/or relocate the item associated with a defined task. In some examples, the AMR may pick a wrong item compared to the item pointed out by the task to transport and/or relocate, causing an unexpected removal. In an example, the AMR may pick the wrong item and drop it within the storage facility 100. The processor 601 may receive visual data from one or more cameras to provide input to the tracking algorithm. In an example, the AMR may have an on-board camera to provide AMR visual data from the AMR to the control system. The processor 601 may further receive the AMR visual data in addition to the visual data provided by one or more cameras deployed within the storage facility (e.g., to the edges, to the ceiling of the storage facility, etc.). As denoted, one or more cameras providing visual data may have field-of-view associated with the original storage position of the tracked item and/or the movement path of the tracked item. The processor 601 may further access item information from the item database about physical attributes of items (e.g., size, dimension, etc.) about one or more identified items within the field of view of one or more cameras monitoring the original storage position of the tracked item in an effort to match the tracked item in order to determine the type of the tracked item (e.g., item 720).

However, although the presence of a comprehensive item tracking via image acquisition devices, which may further be supported through any type of data acquisition devices, there may be uncertainties about movement that are identifiable within the tracked movement of an item. Illustratively, cameras providing the visual data may have blind-spots, making the processor 601 unable to receive real-time (or near real time) data about the movement path of an item removed from the original storage position. In some aspects, one or more physical obstacles may prevent one or more cameras from providing movement path or the position of the tracked item, which may introduce a movement uncertainty for the item. Additionally, there may be other limitations causing a temporary stuttering of information delivery from the sensors. In some examples, tracking algorithms used by the processor 601 may further include predictions which may be employed to predict future position of identified objects based on their previous movements which may allow for a smoother tracking in occluded regions, blind spots of image acquisition devices or sudden changes in movement patterns, which may contribute to movement uncertainties as explained in this disclosure.

In accordance with various aspects described in this disclosure, a movement uncertainty of an item may refer to the lack of precise information regarding the movement or location of the item within the storage facility through performed item tracking operations. This may refer to a designated period of time during an item tracking operation in which the item has not been tracked for various reasons. Illustratively, such reasons may include blind spots in visual coverage of the items, areas within the storage facility not being monitored via image acquisition devices, incorrect classifications of object detection techniques, unpredictable or unrecorded item actions including item movements, and the like.

In accordance with various aspects described herein, the processor 601 may identify movement uncertainties associated with items according to item tracking operations performed by the control system, as illustratively described above. The processor 601 may analyze the tracked movement of the item to identify movement uncertainties.

Illustratively, the processor 601 may monitor the tracked movement of an item being tracked in real-time or near real-time. Additionally, or alternatively, the processor 601 may store tracked item movements into the memory 602 and the processor 601 may analyze stored tracked movement. The processor 601 may perform monitoring or offline-analysis for all tracked items, selected tracked items, a designated group of tracked items. In some examples, the processor 601 may identify movement uncertainties based on information in at least one of the item database, the operational database, and/or the map database.

In some examples, the processor 601 may identify movement uncertainties by identifying sudden movement changes in the tracked movement of the item. For example, the processor 601 may access expected and/or estimated trajectory of the item for the assigned task causing the item movement from the operational database. The processor 601 may compare the expected and/or estimated trajectory with the tracked movement to identify the movement uncertainties. Illustratively, if the item has disappeared from the captured visual data or has deviated from the expected and/or estimated trajectory, the processor 601 may identify a movement uncertainty for the item.

Additionally, or alternatively, the processor 601 may identify movement uncertainties based on anomaly detection performed on the tracked movement of the item. The processor 601 may identify irregularities or unexpected behaviors from the captured visual data or the tracked movement of the item. Such irregularities or unexpected behaviors may include unusual patterns of movement (e.g. switching opposite directions in a designated period of time), or unanticipated occlusions which may be caused by mobile storage facility actors. In an example, the processor 601 may identify unexpected stops without apparent reasons.

Additionally, or alternatively, the processor 601 may identify movement uncertainties based on a temporal analysis to identify inconsistencies. The processor 601 may identify abrupt or irregular speed variations or inactivity periods over a designated time period.

Additionally, or alternatively, the processor 601 may identify movement uncertainties based on analysis of the captured visual data associated with the tracked movement. Illustratively, the processor 601 may analyze the captured visual data and identify visual data (e.g. image frames) in which the tracked item is not present, or occluded.

In some examples, the processor 601 may identify movement uncertainties by comparing designated information provided in the item database and/or the operational database by object detections and/or the tracked movements. In some examples, designated information may include at least one of physical attributes of the tracked item, physical attributes (dimensions) of other items identified within the captured visual data, expected and/or estimated trajectory, location information of the item, designated physical storage unit of the item, assigned tasks.

Accordingly, the processor 601 may monitor assigned tasks from the operational database and match actions indicated by the assigned tasks with performed object detections and tracked movements. In case the processor 601 is unable to match an action with performed object detections and tracked movements, the processor 601 may identify a movement uncertainty.

For example, due to its designated field of view and angle, an image acquisition device may not detect all items in designated physical storage units as physical storage units may be close to each other, and some physical storage units may be occluded by others. Illustratively, an assigned task may indicate a retrieval of a designated item or a placing of an item from one of those physical storage units. The retrieval and/or placing of the item may be associated with the designated physical storage unit being one of the occluded physical storage units (i.e. one of the physical storage units in the area that is not within the captured visual data). The processor 601 may identify, through performed object detections, a storage facility actor arriving to the designated location as indicated by the assigned task. However, the processor 601 may not match the exact item being retrieved due to occlusions in the captured visual data, as illustratively the picked item may also be the item in another occluded physical storage unit. Accordingly, the processor 601 may identify a movement uncertainty.

For example, the processor 601 may identify item movements to be executed based on the warehouse management data and match the identified movements to be executed with the captured visual data. if the processor 601 identifies an item movement to be executed based on the warehouse management data and cannot match this to object detections performed with the captured visual data (i.e. no detection of item movement for the designated item), the processor 601 may identify this action as a movement uncertainty, which may further indicate system malfunction, although this may also occur if the origin of the item movement to be executed is not being monitored by image acquisition devices.

In some examples, the processor 601 may identify item movements according to the captured visual data and check if the identified movement is indicated by the warehouse management data. In this example, if the processor 601 identifies the item movement according to the captured visual data but the processor 601 fails to identify an indication from the warehouse management data, the processor 601 may identify this action as a movement uncertainty. Illustratively, a worker may retrieve an item which is not planned to be retrieved.

The memory 602 may include a movement database. The processor 601 may store information about each identified movement uncertainty into the movement database. In some examples, the movement database may further include information representing tracked movements of items.

The processor 601 may be configured to handle each identified movement uncertainty according to a designated fuzzy algorithm. The processor 601 may store tracked movement of a tracked item including all uncertainties that are identified by the processor 601. In this regard it may be noted that it may be considered as impossible to detect precisely, which is objected was moved unintentionally, from where exactly (origin) and to which exact place (destination). Instead, the processor 601 attributes probabilities regarding each identified movement uncertainty and store them at least for a designated period of time. In other words, each identified movement uncertainty may result in possible movement estimations, each associated with a corresponding probability. Then, upon detection of a missing item, a human operator or the control system (e.g. the processor 401) may check these probability starting from the most likely one, to find the missing item.

Through execution of a fuzzy algorithm the processor 601 may, for each identified movement uncertainty, estimate at least one action for the item and determine a probability of the estimated action. In some examples, the processor 601 may estimate a plurality of actions associated with the movement of the item and determine a corresponding probability for each action. The processor 601 may store estimate actions and corresponding probabilities in the movement database to enhance locating process of lost items within the storage facility. Illustratively, computerized actions may be taken to check for lost items according to stored uncertainty information. Additionally, or alternatively, a human operator may go through the movement database, in particular through estimate actions and corresponding probabilities, and assign tasks accordingly to locate lost items.

The fuzzy algorithm may include a rule-based model including a set of rules and membership functions translating information obtained through captured visual data, other data of data acquisition devices, and the warehouse management system into a set of estimate actions and probabilities. Noting that the warehouse management data may store information about past operations, the mapping of the obtained information to the set of estimate actions and probabilities may be based on information about the past operations.

Illustratively, for an identified movement uncertainty, each action of a plurality of estimate actions may be associated with a movement, which may include a transport movement, an item retrieval movement, an item placing movement, and the like. Each transport movement may include a direction (e.g. a heading).

The processor 601 may estimate actions according to the analysis of the captured visual data obtained from image acquisition devices and comparing actions and objects detected by the captured visual data with the warehouse management data. For example, in an area with limited camera coverage, the processor 601 may, via the fuzzy algorithm, apply the designated rules to interpret the data to estimate actions and probabilities. For example, an item's last known location is near to a blind spot of cameras. The membership functions and rules of the fuzzy algorithm may map the tracked movement of the item ending with the last known location to different locations with different probabilities, which the processor 601 may store them in the memory 602.

The processor 601 may provide input data to the fuzzy algorithm from the warehouse management system, such as the respective task resulting the movement of the item, item retrieval and item placing locations associated with the respective task, physical attributes of the item, and any other information that the fuzzy algorithm may use to enhance its estimates through ruling out possible estimations from the set of estimations.

In accordance with various aspects described herein, the movement database may include for each tracked item multiple values for each designated movement-related information and corresponding probabilities associated with that particular estimation. For example, a tracked item may be associated with multiple item identifiers stored in the item database. Illustratively, multiple items associated with different item identifiers may have transported through a non-monitored zone within a period of time, which the processor 601 may have estimated that the tracked item may be any one of these items in accordance with corresponding determined probabilities.

For example, a tracked item may be associated with multiple item retrieval locations (e.g. physical storage unit identifiers) according to the illustrated case above in which the item is retrieved from a location having multiple occluded physical storage units. Similarly, a tracked item may be associated with multiple item placing locations, in case the item was placed to a physical store unit, which the item placement could not be confirmed by the captured visual data.

In an example, a typical entry within the movement database of a tracked item may be illustrated as below:
Tracked Item A:
   Origin:
      Shelf no: 7, likelihood: 0.9
      Shelf no: 8, likelihood: 0.1
   Identity:
      Item no: 991, likelihood: 0.5
      Item no: 728, likelihood: 0.3
      Item no: 111, likelihood: 0.1
   Track:
      x: 3.0, y: 19.1, timestamp: 218397, covariance:
      x: 3.2, y: 19.0, timestamp: 218398, covariance:
      x: 3.5, y: 18.7, timestamp: 218399, covariance:
      . . .

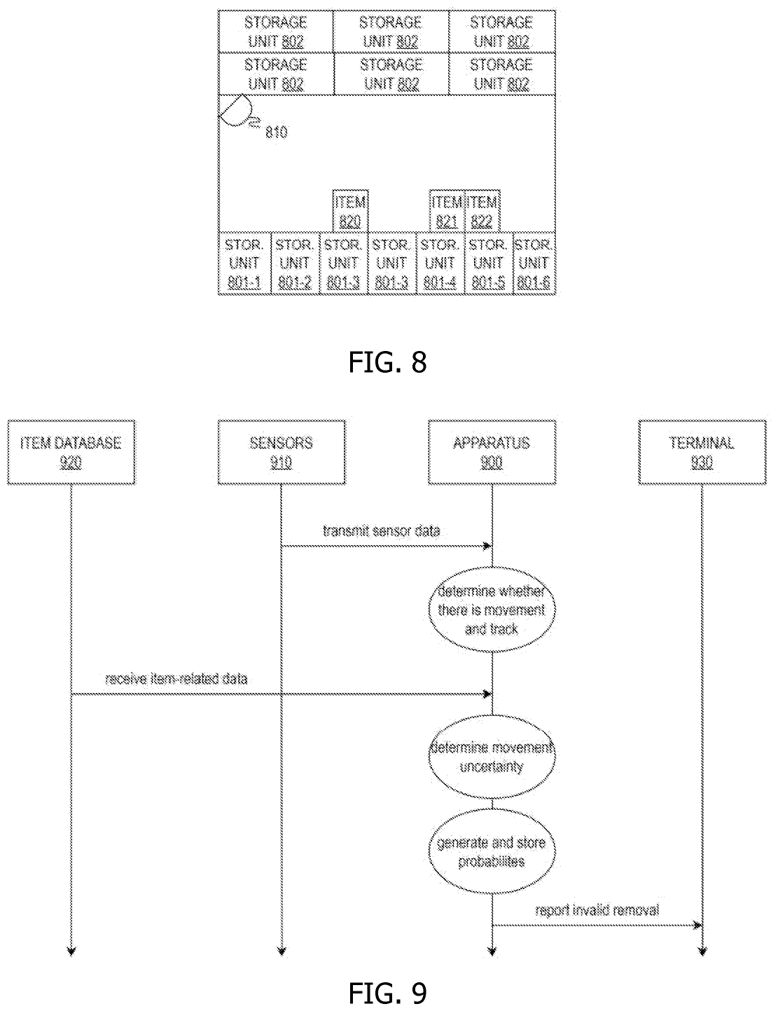

FIG. 8 shows an exemplary storage facility environment in which a camera monitors an array of storage units. Illustratively, the camera 810 may have a field-of-view to monitor the item 820 residing on the storage unit 801-3, the item 821 residing on the storage unit 801-4 and the item 822 residing on the storage unit 801-5. When an AMR or human removes one of the items from the corresponding storage unit, it may not be possible for the camera 810 to capture precisely which item is removed from its original storage position. That may occur due to the restricted imaging capabilities of the camera 810, the similar packaging of the items 820, 821, and 822, etc., which may result in providing captured visual data without precise indication to the control system. The processor 601 may identify an item is removed and transported.

The processor 601 may access the item database to identify the items stored in the array of the storage unit 801 to match the removed item, based on the sensor data received form the camera 810, with an item stored in the item database. Based on the information within the item database and the tracked movement, the processor 601 may identify a movement uncertainty and generate likelihood scores based on the movement uncertainty of one or more of movement information estimated spatial trajectories, original storage position of the tracked item, and an identifier of the item. In some aspects, the generated likelihood scores may refer to a probability. The processor 601 may store each probability for each entry of the movement information in the memory 602.

FIG. 9 shows an illustrative example of a messaging diagram. A storage facility control system (e.g., control system 200 including the apparatus 600) may receive, via a processor (e.g., processor 601) of captured visual data from the image acquisition devices (e.g., cameras) 910 deployed in the storage facility environment and/or integrated/attached to an AMR. Based on the captured visual data, the apparatus 900 may track the movement of a corresponding item removed (e.g., relocated, transported) from its original storage position. The apparatus 900 may further receive item-related data related to one or more items to estimate the removed item based on the sensor data. The apparatus 900, via the processor, may identify a movement uncertainty based on the tracked movement and item-related data received from the item database. The processor 601 may determine a likelihood (i.e., probability) associated with movement uncertainty and store the determined probability in the memory 602.

In some aspects, the processor 601 may evaluate whether the movement track of the removed item is associated with a task assigned by the processor 601 to a human operator and/or an AMR. In some examples, the processor 601 may flag the movement of the item as an invalid action may transmit the exception to a terminal operable by a human supervisor/manager. In some cases, the processor 601 may determine a task associated with removal/transportation of a corresponding item. However, the processor 601 may not detect a movement based on the sensor data indicating a task failure. In that case, the processor 601 may transmit information representing the failure to the terminal 930 for further check.

The processor 601 may determine an action to be taken in case of invalid removal of a corresponding item. Accordingly, the processor 601 may report the invalid removal to a human operator/supervisor via the terminal. Additionally, or alternatively, the processor 601 may determine a countermeasure. The terminal 930 may include a user interface (e.g. the user interface 206), a display and peripherals for a human manager/supervisor to interact with. In some cases, the stored probabilities based on the movement uncertainty of a corresponding item may be displayed on the display of the terminal 930. The human supervisor/manager may assign a task to locate/find the removed item.

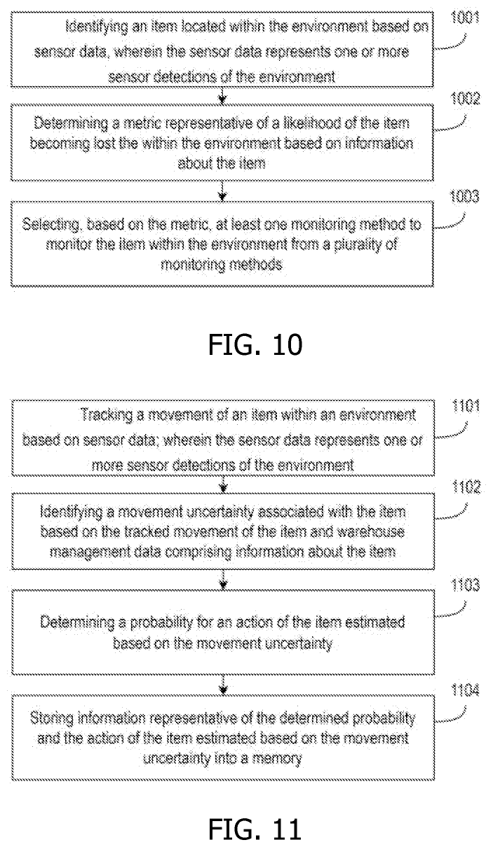

FIG. 10 shows an example of a method. The method may include identifying 1001 an item located within the environment based on sensor data, wherein the sensor data represents one or more sensor detections of the environment; determining 1002 a metric representative of a likelihood of the item becoming lost the within the environment based on information about the item; and selecting 1003, based on the metric, at least one monitoring method to monitor the item within the environment from a plurality of monitoring methods.

FIG. 11 shows an example of a method. The method may include tracking 1101 a movement of an item within an environment based on sensor data; wherein the sensor data represents one or more sensor detections of the environment; identifying 1102 a movement uncertainty associated with the item based on the tracked movement of the item and warehouse management data comprising information about the item; determining 1103 a probability for an action of the item estimated based on the movement uncertainty; and storing 1104 information representative of the determined probability and the action of the item estimated based on the movement uncertainty into the memory.

The following examples pertain to further aspects of this disclosure.

In example 1A, the subject matter includes an apparatus including a memory and a processor configured to: identify an item located within an environment based on sensor data, wherein the sensor data represents one or more sensor detections of the environment; determine a metric representative of a likelihood of the item becoming lost within the environment based on information about the item; and select, based on the metric, at least one monitoring method to monitor the item within the environment from a plurality of monitoring methods.

In example 2A, the subject matter of example 1A, wherein the processor is further configured to send control information to at least one monitoring entity configured to perform the at least one monitoring method, wherein the control information instructs the at least one monitoring entity to monitor the item.

In example 3A, the subject matter of example 1A or example 2A, wherein the processor is further configured to perform the at least one monitoring method to monitor the item within the environment.

In example 4A, the subject matter of any one of examples 1A to 3A, wherein the processor is further configured to determine the metric based on the sensor data including sensor information about the item.

In example 5A, the subject matter of any one of examples 1A to 4A, wherein the processor is further configured to determine the metric based on stored information about the item, wherein the stored information includes at least one of contextual data about the item or warehouse management data about the item.

In example 6A, the subject matter of any one of examples 1A to 5A, wherein the processor is further configured to determine the metric based on past operation information representative of item storage and item transport operations stored in the memory.

In example 7A, the subject matter of any one of examples 1A to 6A, wherein the processor is further configured to monitor the item within the environment; and wherein the processor is further configured to determine the metric based on identified events associated with the item.

In example 8A, the subject matter of any one of examples 1A to 7A, wherein the processor is further configured to monitor further items within the environment; wherein the processor is further configured to determine the metric based on identified events associated with the further items.

In example 9A, the subject matter of any one of examples 1A to 8A, wherein the processor is further configured to monitor behavior of humans or autonomous robots within the environment; wherein the processor is further configured to determine the metric based on monitored behavior of humans or autonomous robots within the environment.

In example 10A, the subject matter of any one of examples 1A to 9A, wherein the processor is further configured to select the at least one monitoring method based on resource information representative of available resources associated with monitoring the item.

In example 11A, the subject matter of any one of examples 1A to 10A, wherein the processor is further configured to determine a plurality of metrics for a plurality of identified items within the environment, wherein each metric of the plurality of metrics is representative of a corresponding likelihood of a corresponding item of the plurality of identified items becoming lost within the environment; wherein the processor is further configured to allocate monitoring resources to selected identified items of the plurality of items based on estimated costs of the selected items of the plurality of items.

In example 12A, the subject matter of example 11A, wherein the processor is further configured to allocate the monitoring resources based on ownership information representative of an ownership of each selected identified item of the selected identified items.

In example 13A, the subject matter of example 11A or example 12A, wherein the processor is further configured to estimate a cost for each identified item of the plurality of identified items based on corresponding item information about the corresponding identified item.

In example 14A, the subject matter of any one of examples 1A to 13A, wherein the processor is further configured to determine a storage location for the item or a movement path for a transport of the item within the environment based on the metric.

In example 15A, the subject matter of any one of examples 1A to 14A, further may include the plurality of sensors; and a monitoring system configured to monitor the environment.

In example 16A, a device may include: an interface configured to communicate with a monitoring entity of the environment; a processor configured to: identify an item within the environment based on sensor data, wherein the sensor data represents one or more sensor detections of the environment; determine a metric representative of a likelihood of the item within the environment becoming lost based on information about the item; and instruct the monitoring entity to monitor the item within the environment according to a monitoring method selected from a plurality of monitoring methods based on the metric.

In example 17A, the device of example 16A, wherein the device is further configured according to aspects described in this disclosure, in particular in any one of examples 2A to 15A.

In example 18A, the subject matter includes a method including: identifying an item located within the environment based on sensor data, wherein the sensor data represents one or more sensor detections of the environment; determining a metric representative of a likelihood of the item becoming lost the within the environment based on information about the item; and selecting, based on the metric, at least one monitoring method to monitor the item within the environment from a plurality of monitoring methods.

In example 19A, the subject matter of example 18A, further may include sending control information to at least one monitoring entity configured to perform the at least one monitoring method, wherein the control information instructs the at least one monitoring entity to monitor the item.

In example 20A, the subject matter of example 18A or example 19A, further may include performing the at least one monitoring method to monitor the item within the environment.

In example 21A, the subject matter of any one of examples 18A to 20A, further may include determining the metric based on the sensor data including sensor information about the item.

In example 22A, the subject matter of any one of examples 18A to 21A, further may include determining the metric based on stored information about the item, wherein the stored information includes at least one of contextual data about the item or warehouse management data about the item.

In example 23A, the subject matter of any one of examples 18A to 22A, further may include determining the metric based on past operation information representative of item storage and item transport operations stored in the memory.

In example 24A, the subject matter of any one of examples 18A to 23A, further may include monitoring the item within the environment; and determining the metric based on identified events associated with the item.

In example 25A, the subject matter of any one of examples 18A to 24A, further may include monitoring further items within the environment; and determining the metric based on identified events associated with the further items.

In example 26A, the subject matter of any one of examples 18A to 25A, further may include monitoring behavior of humans or autonomous robots within the environment; and determining the metric based on monitored behavior of humans or autonomous robots within the environment.

In example 27A, the subject matter of any one of examples 18A to 26A, further may include selecting the at least one monitoring method based on resource information representative of available resources associated with monitoring the item.

In example 28A, the subject matter of any one of examples 18A to 27A, further may include determining a plurality of metrics for a plurality of identified items within the environment, wherein each metric of the plurality of metrics is representative of a corresponding likelihood of a corresponding item of the plurality of identified items becoming lost within the environment; and allocating monitoring resources to selected identified items of the plurality of items based on estimated costs of the selected items of the plurality of items.

In example 29A, the subject matter of example 28A, further may include allocating the monitoring resources based on ownership information representative of an ownership of each selected identified item of the selected identified items.

In example 30A, the subject matter of example 28A or example 29A, further may include estimating a cost for each identified item of the plurality of identified items based on corresponding item information about the corresponding identified item.

In example 31A, the subject matter of any one of examples 18A to 30A, further may include determining a storage location for the item or a movement path for a transport of the item within the environment based on the metric.

In example 32A, a method may include: communicating with a monitoring entity of the environment; identifying an item within the environment based on sensor data, wherein the sensor data represents one or more sensor detections of the environment; determining a metric representative of a likelihood of the item within the environment becoming lost based on information about the item; and instructing the monitoring entity to monitor the item within the environment according to a monitoring method selected from a plurality of monitoring methods based on the metric.

In example 33A, the subject matter of example 32A, wherein the method further includes any one of the aspects described in this disclosure, in particular in any one of examples 19A to 31A.

In example 34A, a non-transitory computer-readable medium including one or more instructions which, if executed by a processor, cause the processor to perform the method of any one of examples 18A to 32A.

In example 1B, the subject matter includes an apparatus including a memory and a processor configured to: track a movement of an item within an environment based on sensor data; wherein the sensor data represents one or more sensor detections of the environment; identify a movement uncertainty associated with the item based on the tracked movement of the item and warehouse management data including information about the item; determine a probability for an action of the item estimated based on the movement uncertainty; and store information representative of the determined probability and the action of the item estimated based on the movement uncertainty into the memory.

In example 2B, the subject matter of example 1B, wherein the processor is further configured to estimate a plurality of actions for the item including the action in response to the identified movement uncertainty based on the sensor data and the information about the item; and wherein the stored information includes the estimated one or more actions for the item.

In example 3B, the subject matter of example 2B, wherein the processor is further configured to determine a corresponding probability for each action of the one or more actions for the item including the action and the probability based on the sensor data and the information about the item; and wherein the stored information includes the corresponding probability for each action of the one or more actions for the item.

In example 4B, the subject matter of any one of examples 1B to 3B, wherein the processor is further configured to store information representative of the tracked movement of the item into the memory.

In example 5B, the subject matter of any one of examples 1B to 4B, wherein the warehouse management data further includes information about other items within the environment.

In example 6B, the subject matter of any one of examples 1B to 5B, wherein the plurality of sensors includes at least one visual sensor including a field of view; and wherein the processor is further configured to track the movement of the item based on other items within the field of view and the information about the other items within the field of view.

In example 7B, the subject matter of example 6B, wherein the information about the other items includes at least one of locations of the other items; packaging sizes of the other items; visual markings of the other items; or characteristics of the other items.

In example 8B, the subject matter of any one of examples 1B to 7B, wherein the processor is configured to detect, to identify the movement uncertainty, at least one of the following: a removal of the item; a drop of the item; or a misplacement of the item.

In example 9B, the subject matter of any one of examples 1B to 8B, wherein the information about the item includes information representing at least one of an origin of the movement of the item or a destination of the movement of the item; and wherein the processor is configured to identify the item from the sensor data based on at least one of the origin of the movement of the item or the destination of the movement of the item.

In example 10B, the subject matter of any one of examples 1B to 9B, wherein the processor is configured to analyze the tracked movement of the item to identify the movement uncertainty.

In example 11B, the subject matter of any one of examples 1B to 10B, wherein the warehouse management data includes one or more expected movements of the item; and wherein the processor is further configured to compare the tracked movement of the item with the one or more expected movements of the item.

In example 12B, the subject matter of any one of examples 1B to 11B, wherein the processor is further configured to encode information representative of an identified movement uncertainty including at least one of an indication of the identified movement uncertainty; a location of the identified movement uncertainty, or a time of the identified movement uncertainty.

In example 13B, the subject matter of any one of examples 1B to 12B, further may include a user interface configured to receive instructions; wherein the processor is configured to search for identified movement uncertainties of a plurality of items including the item based on the instructions.

In example 14B, the subject matter of any one of examples 1B to 13B, further may include the plurality of sensors configured to monitor the environment.

In example 15B, a device may include: a processor configured to: monitor a transport of an item within an environment based on sensor data, wherein the sensor data represents one or more sensor detections of the environment; identify a movement uncertainty associated with the item based on the monitored transport of the item and warehouse management data including item information about the item; estimate an action for the item based on the movement uncertainty; determine a probability for the estimated action; and a memory configured to store information representative of the estimated action and the probability for the estimated action.

In example 16B, the device of example 15B, wherein the device is further configured according to aspects described in this disclosure, in particular in any one of examples 2B to 14B.

In example 17B, the subject matter includes a method including: tracking a movement of an item within an environment based on sensor data; wherein the sensor data represents one or more sensor detections of the environment; identifying a movement uncertainty associated with the item based on the tracked movement of the item and warehouse management data including information about the item; determining a probability for an action of the item estimated based on the movement uncertainty; storing information representative of the determined probability and the action of the item estimated based on the movement uncertainty into the memory.

In example 18B, the subject matter of example 17B, further may include estimating a plurality of actions for the item including the action in response to the identified movement uncertainty based on the sensor data and the information about the item; and wherein the stored information includes the estimated one or more actions for the item.

In example 19B, the subject matter of example 18B, further may include determining a corresponding probability for each action of the one or more actions for the item including the action and the probability based on the sensor data and the information about the item; and wherein the stored information includes the corresponding probability for each action of the one or more actions for the item.

In example 20B, the subject matter of any one of examples 17B to 19B, further may include storing information representative of the tracked movement of the item into the memory.

In example 21B, the subject matter of any one of examples 17B to 20B, wherein the warehouse management data further includes information about other items within the environment.

In example 22B, the subject matter of any one of examples 17B to 21B, wherein the plurality of sensors includes at least one visual sensor including a field of view; and wherein the method further includes tracking the movement of the item based on other items within the field of view and the information about the other items within the field of view.

In example 23B, the subject matter of example 22B, wherein the information about the other items includes at least one of locations of the other items; packaging sizes of the other items; visual markings of the other items; or characteristics of the other items.

In example 24B, the subject matter of any one of examples 17B to 23B, further may include detecting, to identify the movement uncertainty, at least one of the following: a removal of the item; a drop of the item; or a misplacement of the item.

In example 25B, the subject matter of any one of examples 17B to 24B, wherein the information about the item includes information representing at least one of an origin of the movement of the item or a destination of the movement of the item; and wherein the method further includes identifying the item from the sensor data based on at least one of the origin of the movement of the item or the destination of the movement of the item.

In example 26B, the subject matter of any one of examples 17B to 25B, further may include analyze the tracked movement of the item to identify the movement uncertainty.

In example 27B, the subject matter of any one of examples 17B to 26B, wherein the warehouse management data includes one or more expected movements of the item; and wherein the method further includes comparing the tracked movement of the item with the one or more expected movements of the item.

In example 28B, the subject matter of any one of examples 17B to 27B, further may include encoding information representative of an identified movement uncertainty including at least one of an indication of the identified movement uncertainty; a location of the identified movement uncertainty, or a time of the identified movement uncertainty.

In example 29B, the subject matter of any one of examples 17B to 28B, further may include searching for identified movement uncertainties of a plurality of items including the item based on the instructions.

In example 30B, the subject matter of any one of examples 17B to 29B, monitoring, via the plurality of sensors, the environment.

In example 31B, a method including: monitoring a transport of an item within an environment based on sensor data, wherein the sensor data represents one or more sensor detections of the environment; identifying a movement uncertainty associated with the item based on the monitored transport of the item and warehouse management data including item information about the item; estimating an action for the item based on the movement uncertainty; determining a probability for the estimated action; and storing information representative of the estimated action and the probability for the estimated action.

In example 32B, the method of example 31B, wherein the method further includes any one of the aspects described in this disclosure, in particular in any one of examples 18B to 30B.

In example 33B, a non-transitory computer-readable medium including one or more instructions which, if executed by a processor cause the processor to perform the method of any one the examples 18 to 32B.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context of this disclosure, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

The term “user device” is intended to refer to a device of a user (e.g. occupant) that may be configured to provide information related to the user. The user device may exemplarily include a mobile phone, a smart phone, a wearable device (e.g. smart watch, smart wristband), a computer, etc.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

What is claimed is:

1. An apparatus comprising a memory and a processor configured to:
identify an item located within an environment based on sensor data, wherein the sensor data represents one or more sensor detections of the environment;
determine a metric representative of a likelihood of the item becoming lost within the environment based on information about the item; and
select, based on the metric, at least one monitoring method to monitor the item within the environment from a plurality of monitoring methods.

2. The apparatus of claim 1,
wherein the processor is further configured to send control information to at least one monitoring entity configured to perform the at least one monitoring method, wherein the control information instructs the at least one monitoring entity to monitor the item.

3. The apparatus of claim 1,
wherein the processor is further configured to perform the at least one monitoring method to monitor the item within the environment.

4. The apparatus of claim 1,
wherein the processor is further configured to determine the metric based on stored information about the item, wherein the stored information comprises at least one of contextual data about the item or warehouse management data about the item.

5. The apparatus of claim 1,
wherein the processor is further configured to determine the metric based on past operation information representative of item storage and item transport operations.

6. The apparatus of claim 1,
wherein the processor is further configured to monitor behavior of humans or autonomous robots within the environment; and
wherein the processor is further configured to determine the metric based on monitored behavior of humans or autonomous robots within the environment.

7. The apparatus of claim 1,
wherein the processor is further configured to determine a plurality of metrics for a plurality of identified items within the environment, wherein each metric of the plurality of metrics is representative of a corresponding likelihood of a corresponding item of the plurality of identified items becoming lost within the environment;
wherein the processor is further configured to allocate monitoring resources to selected identified items of the plurality of items based on estimated costs of the selected items of the plurality of items.

8. The apparatus of claim 7,
wherein the processor is further configured to allocate the monitoring resources based on ownership information representative of an ownership of each selected identified item of the selected identified items.

9. The apparatus of claim 1,
wherein the processor is further configured to determine a storage location for the item or a movement path for a transport of the item within the environment based on the metric.

10. A non-transitory computer-readable medium comprising one or more instructions which, if executed by a processor, cause the processor to:
identify an item within an environment based on sensor data, wherein the sensor data represents one or more sensor detections of the environment;
determine a metric representative of a likelihood of the item within the environment becoming lost based on information about the item; and
instruct a monitoring entity to monitor the item within the environment according to a monitoring method selected from a plurality of monitoring methods based on the metric.

11. The non-transitory computer-readable medium of claim 10,
wherein the one or more instructions further cause the processor to:
monitor behavior of humans or autonomous robots within the environment; and
determine the metric based on monitored behavior of humans or autonomous robots within the environment.

12. An apparatus comprising a memory and a processor configured to:
track a movement of an item within an environment based on sensor data; wherein the sensor data represents one or more sensor detections of the environment;
identify a movement uncertainty associated with the item based on the tracked movement of the item and warehouse management data comprising information about the item;
determine a probability for an action of the item estimated based on the movement uncertainty;
store information representative of the probability and the action of the item estimated based on the movement uncertainty into the memory.

13. The apparatus of claim 12,
wherein the processor is further configured to estimate a plurality of actions for the item comprising the action in response to the identified movement uncertainty based on the sensor data and the information about the item; and
wherein the stored information comprises the estimated one or more actions for the item.

14. The apparatus of claim 13,
wherein the processor is further configured to determine a corresponding probability for each action of the one or more actions for the item including the action and the probability based on the sensor data and the information about the item; and
wherein the stored information comprises the corresponding probability for each action of the one or more actions for the item.

15. The apparatus of claim 12,
wherein the processor is further configured to store information representative of the tracked movement of the item into the memory.

16. The apparatus of claim 12,
wherein the warehouse management data further comprises information about other items within the environment.

17. The apparatus of claim 12,
wherein the sensor data comprises at least one visual data representing a field of view of an image acquisition device; and
wherein the processor is further configured to track the movement of the item based on other items within the field of view and the information about the other items within the field of view.

18. The apparatus of claim 17,
wherein the information about the other items comprises at least one of locations of the other items; packaging sizes of the other items; visual markings of the other items; or
characteristics of the other items.

19. The apparatus of claim 12,
wherein the processor is configured to detect, to identify the movement uncertainty, at least one of a removal of the item, a drop of the item, or a misplacement of the item.

20. The apparatus of claim 12,
wherein the information about the item comprises information representing at least one of an origin of the movement of the item or a destination of the movement of the item; and
wherein the processor is configured to identify the item from the sensor data based on at least one of the origin of the movement of the item or the destination of the movement of the item.
